(19) United States
(12) Patent Application Publication
(10) Pub. No.: US 2016/0026730 A1
(43) Pub. Date: Jan. 28, 2016

(54) HTML5-BASED DOCUMENT FORMAT WITH PARTS ARCHITECTURE

(71) Applicant: Russell Hasan, Norwalk, CT (US)

(72) Inventor: Russell Hasan, Norwalk, CT (US)

(21) Appl. No.: 14/803,076

(22) Filed: Jul. 19, 2015

Related U.S. Application Data
(60) Provisional application No. 62/028,175, filed on Jul. 23, 2014.

(51) Int. Cl. G06F 17/30; G06F 17/21

(52) U.S. Cl. CPC G06F 17/30896; G06F 17/218; G06F 17/212; G06F 17/217

(57) ABSTRACT

One embodiment of a web-based word processor, spreadsheet, and presentations computer program that creates documents in an HTML5-based document format that breaks documents into parts and pages in order to make documents easy for use on laptops, tablets, and smartphones, and which chooses document parts from twenty one different types of parts, with each parts type taking advantage of the various features of HTML5 in different ways. Other embodiments are described and shown.

### CROSS-REFERENCE TO RELATED APPLICATIONS

This application claims the benefit of provisional patent application Ser. No. 62/028,175, filed 2014 Jul. 23 by the present inventor.

### BACKGROUND

### Prior Art

Office productivity software is the general term for software that performs the tasks of a word processor, spreadsheet, and presentation software (most often, slideshow-style presentations). Word processing, in contrast to mere text editing, is the manipulation of text with advanced features, styles, etc. Spreadsheets generally display a table of cells and let the user enter data into the cells and run mathematical calculations on cells. Presentations take a deck of slides where each slide come from user input, and runs the slideshow. Office productivity dates back to the earliest Apple personal computers of the early 1980s. Since the 1980s, the dominant, virtually monopolistic major player in the area has been Microsoft Office, which includes Microsoft Word, Excel, and PowerPoint. As virtually everyone has used these programs at some point, little need be said about the prior art which the reader will not already have some knowledge of. However, it is worth observing that, without making any comment as to whether they are good software or bad software, it can be said that Microsoft Word, Excel, and PowerPoint tend to have mostly features that could have existed in the year 2000, and tend not to have features that rely heavily on new or recent technology.

Aside from Office, several other office productivity suites which include word processors, spreadsheets, and presentation programs already exist, such as OpenOffice and OfficeLibre. But problems have arisen that are left unsolved by the prior art. Most office productivity software runs off the operating system and are therefore limited to being run only on that operating system. Thus, a document created on one operating system may not display or function properly in a different operating system. The inability to run on different operating systems of the prior art also manifests itself as being limited mainly to laptops and desktops, and to not be designed to run on tablets or smartphones, which often run a different operating system than a laptop or desktop. Those office productivity suites that can run well on smartphones are generally limited to smartphone apps, which cannot also run on laptops or desktops.

Some office suites have tried to deploy through a web browser to get around the limitations of running off the OS. However, those computer programs that run through a web browser generally copy the design of a laptop-based office suite and translate it into a web page, instead of designing an office productivity suite that is truly tailored to being deployed as a web page and which takes full advantage of all the features of today's web pages.

In terms of how to save document data that has been entered, web application-based office suites that save files from the client to the server and that can run on smartphones generally make one of two mistakes, either forcing the user to save the whole document, which is too big and takes too long and risks data loss if an error occurs before saving or if the mobile connection is lost, or else saving every change every time any new data is entered, even for one new letter, which results in almost constant save commands that overuse data transfer and are needlessly resource-consuming.

### SUMMARY

In accordance with one embodiment a document comprised of document parts selected from twenty-one types of parts comprising word processor parts, spreadsheet parts, and presentation parts, stored on a server and outputted as web pages in a web browser using the new innovations of HTML5 for web pages.

### Advantages

Accordingly several advantages of one or more aspects are as follows: to provide electronic documents that can be edited and viewed on any computer or device with a web browser, to provide a parts architecture that breaks documents into parts sized to be easily viewed and manipulated on a smartphone or laptop, to provide twenty-one parts types which span the range of word processing, spreadsheets, and presentations, and to provide math and logic spreadsheet data processing that is analytically powerful yet easy to use, to provide a service that enables document creation and editing on a smartphone or mobile device with a small touchscreen by using electronic document parts sized to be small enough to fit neatly on a small screen and broken up into items that can be selected by touching the item on the touchscreen, that can be useful on any device including a smartphone, a tablet, a laptop or a desktop, that solves the problem of how to manage collaboration and referencing when many users may need to simultaneously work on one electronic document, that exploits all of the new features of an HTML5 web page in order to generate rich documents with a full set of word processor, spreadsheet, and presentation features, that creates one document which solves the problems of someone who needs to draft a text document like a contract or a book and solves the problems of someone who needs to give a presentation to an audience through a computer screen or through a projector or television attached to a computer output device and solves the problems of someone who needs to organize cells of data and use powerful math and logic operations to process said data, all with one document format. Other advantages of one or more aspects will be apparent from a consideration of the drawings and ensuing description.

### DRAWINGS

### Figures

FIG. 1 shows a design of an electronic document edited using the three-tier architecture where a user interfaces with a web browser, the web browser communicated with a web server, and the web server writes and reads data from a data server.

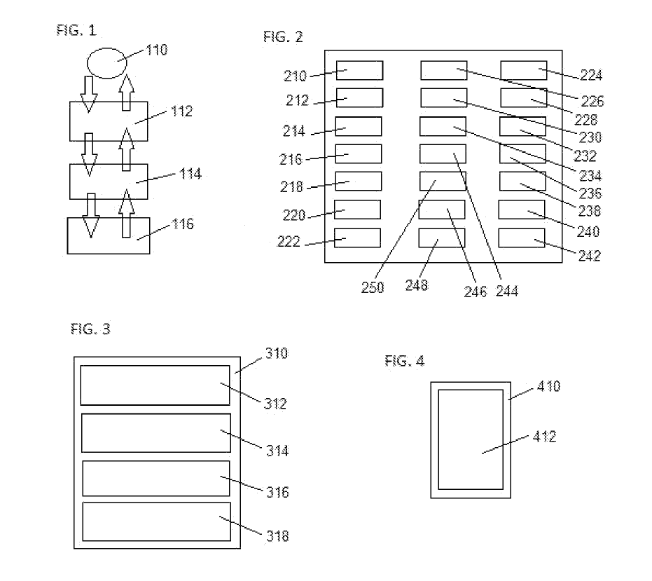

FIG. 2 shows a list of the twenty-one parts types, such as is viewed when selecting a type for a new part.

FIG. 3 shows an output web page such as is viewed in a laptop with parts united into a page by reference to sequence numbers and a pagination number and wherein the page of parts fills the display.

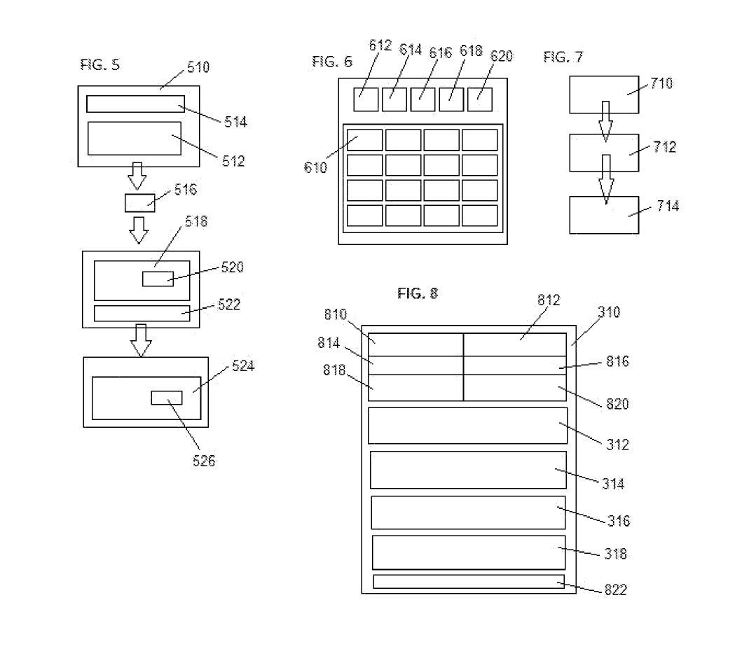

FIG. 4 shows an output web page such as is viewed in a smartphone with one part filling the display.

FIG. 5 shows a visual flowchart of software logic for styling words of text using the Text Word Object Model.

FIG. 6 shows a spreadsheet table of cells with commands including math operations and logic operations.

FIG. 7 shows a flowchart of the process whereby data files can be uploaded to the server for spreadsheet data processing.

FIG. 8 shows an output web page with parts combined into a document page with commands at the top of the page and a page break at the bottom of the page.

FIG. 9 shows a flowchart diagram of the AllRef system whereby a part is edited by one user but is viewable by many users.

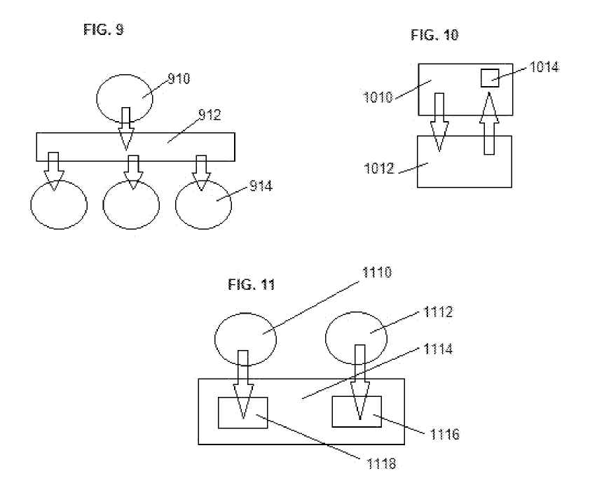

FIG. 10 shows an illustration of a web browser sending a request for a public document page and receiving a public output web page from the server as a response.

FIG. 11 shows a diagram of the AllRef system whereby a part can only be edited by one user at one time but multiple different parts in the same document may be edited each by a different user at one time.

### DRAWINGS

### Reference Numerals

110 a user
112 a computer device executing a web browser
114 a computer executing a web server
116 a computer executing a data server
210 a text part
212 a list part
214 a table of text part
216 a fillable form part
218 a heading part
220 a link part
222 a bookmark part
224 a page break part
226 a table of contents part
228 a table of data part
230 a math operations part
232 a logic operations part
234 a template of data part
236 a video part
238 an audio part
240 an image part
242 a style animation part
244 a dynamic image part
246 a dynamic animation part
248 a dynamic graph image part
250 a dynamic graph animation part
310 an electronic document output page showing an electronic document page
312 a first part outputted using HTML5
314 a second part outputted using HTML5
316 a third part outputted using HTML5
318 a fourth part outputted using HTML5
410 a smartphone or mobile device display
412 a part outputted using HTML5
510 word processor text part input page
512 hypertext markup language form text area input
514 a set of empty span tags on the web page
516 a Text Word Object Model function that slices a text input into fragments delimited by a delimiter, stores each fragment as one item in an array of words, attaches each span in the set of empty spans to a Document Object Model variable, outputs each word from the array of words to the HTML of each one of the spans such that the number of the word in the array matches the number of the span on the page, creates DOM input events for each span, and creates event listeners for each span input event
518 outputted text where each word is attached to an input event
520 a word selected by an input event
522 a menu of options to apply formatting styles to a word
524 word processor text part outputted to be viewed
526 word outputted with formatting style applied to it
610 a spreadsheet table of cells
612 a list of math operations
614 a list of logic operations
616 a command to select a cell
618 a command to select a cell for the result of a math or logic operation applied to other selected cells
620 a command to assign a text name to a cell data value
710 a name-value pairs file is uploaded to the server
712 data values are changed to values matching the names of the data values in the name-value pairs file
714 data values are recalculated and outputted
810 a button to flip to the previous page
812 a button to flip to the next page
814 a button to flip to the first page in the document
816 a button to flip to the last page in the document
818 a button to turn edit mode on
820 a button to turn read mode on
822 a page break part displayed at the footer of an output page
910 an editing user being one user having permission to edit a document part
912 a document part after a final save command is inputted by the editing user
914 many accessing users viewing the document part after the final save
1010 a web browser sending a request for a public document page
1012 a server replying to the web browser's request by sending a public web page if the document is public
1014 a public document output web page rendering in the web browser
1110 a first user
1112 a second user
1114 a document
1116 a first document part that is being edited by a user but only may not be edited by both users at once
1118 a second document part that is being edited by the other user and may not be edited by both users at once

### DETAILED DESCRIPTION

### First Embodiment

In one embodiment, an electronic document is comprised of parts selected from twenty-one types of parts which include word processor parts 210-226, spreadsheet parts 228-234, and presentation parts 236-250, outputted using HTML5 web pages 310, 410. Parts are assigned to pages, and a page can output as an output web page on a laptop display (FIG. 3) or a part can output as an output web page on a smartphone display (FIG. 4).

In one embodiment, the hardware is what is referred to in computer science as the three tier architecture, comprised of the user-facing front end, the data processing back end, and the data storage behind the back end, which is illustrated in FIG. 1. In one embodiment the front end is a web browser interpreting HTML, the back end is a server-side script coded in PHP (although other embodiments coded in, for example, Java EE or ASP.Net can easily be imagined), and the data storage is a database coded in SQL (although other embodiments coded in NOSQL are within the realm of consideration). A diagram of the hardware (FIG. 1) shows this arrangement, with a user 110 who faces a computer executing web browser software 112, which displays document input and output web pages. The computer executing a web browser is connected via the internet to a computer executing a web server 114 which runs a server-side script. The computer running a web server 114 is connected to a data storage device or computer readable memory 116 which holds the data comprising document content. For specific examples of hardware, a Dell laptop running Windows OS or an Apple iPhone running iOS could be the computer running a web browser, and a dedicated server built by Cisco running an Intel CPU could be the computer running a web server, and this Cisco server could also run an Oracle SQL database. These examples are, of course, not intended to be limiting.

### Operation

This invention utilizes a new development in computer technology, namely the implementation of HTML5 in modern web browsers, to create a system or method for creating and editing electronic documents which exploit HTML5's new capabilities in order to possess a rich set of features beyond what word processors, spreadsheets, and presentations have had in the past. The user of this invention can open a new document, create a new document part, select a part type for the part from a list of twenty-one parts types, create the part using the user interface and software logic described herein, edit the part using the user interface and software logic described herein, and repeat this process to create a full document consisting of multiple document parts.

The parts are stored in a server database using the data design described herein, and users can refer to documents and document parts in messages using the referencing method described herein, such that messages can include links to places in the documents because each part has one data storage location and all references to a part refer to that data storage location. The parts type list is designed to provide the functionality of a full office productivity suite including word processor, spreadsheet, and presentation, but the invention implements these features using details which have not been implemented in the prior art. The software uses a new innovation called parts architecture, which is novel to this embodiment, that breaks a document into parts small enough to be viewed on a smartphone, but which also groups parts into pages for easy viewing on a laptop, which enables the software to run as one web-based system easily used by smartphones or laptops through a web browser. Each part is designed with features that make it easy to create, edit, or view through a web browser running on any device, including a laptop, tablet, or smartphone, including smartphones whose primary input/output device is a small touch screen.

The area of technology at issue in this patent is web development and web applications. A web application is a software program run on a web server which gets input from and gives output to humans by means of web pages. Thus, it is relevant to know the following web application computer languages, which form the common foundation for many web applications: HTML5, CSS3, JavaScript, PHP, and SQL. However, the software could be coded using Java EE, Asp.Net, Python, or any other server-side scripting language.

Word processors, spreadsheets, and presentation software are typically grouped into a category known as office productivity software. Office productivity software has been around for decades. However, the embodiments describe a new document format for an office productivity document, which makes use of HTML5, which is a new computer technology. Thus, it may be useful to provide some background on the features of HTML and the features which are new in HTML5.

HTML stands for hypertext markup language. It is the most popular computer programming language to use to build web pages. A typical web page works by means of the following system: the user has a personal computer or device which has a web browser. The user types in the URL (Uniform Resource Locator), in other words a web address, or else clicks on a link. This causes the web browser to send a request through the internet to a web server. This request reaches a web server. The web server then analyzes the request and sends a response comprised of one or more blocks of HTML code back through the internet to the web browser. The web browser then interprets the HTML code and renders the web page that the user can see, read, and interact with.

Programs which run on the web server are typically called server-side scripts, whereas programs which run on the web browser are called client-side programs. A web server is often connected to a data server. When the system includes a client-side web browser and a web server connected to a data server, this is referred to as the three-tier architecture. In a three-tier architecture system, the web browser sends data to the web server, the web server then processes the data and stores data in the data server, the web server also reads data from the data server, and the server-side script processes data from the data server and the result of this processing leads to the dynamic generation of HTML and other data which the web server then sends to the web browser. In other words, the web server uses the data server for data storage and uses the web browser to interface with the user.

For many web applications the data server runs an SQL database. An SQL database stores data in tables consisting of fields and records, where a record is a series of fields such that the table can be visualized with the records as rows and the fields as columns. Typically one record corresponds to one data entry and each field in the record holds a different data value for that data entry.

The standard features of a web page coded in HTML include text, images, and links Text is coded as text strings in the document body, images are coded using image tags, and links are coded using anchor tags. A tag is a unit of HTML code that identifies an object in a web page. Typically, the visual appearance of a web page is coded using a language called CSS (which stands for cascading style sheets). CSS is related to HTML in that HTML is used for content and CSS is used for visual appearance. A new version of CSS called CSS3 has been released to complement HTML5, and CSS3 also adds new features used by the embodiments. Also, a web page can add functionality by embedding a client-side program in the web page, often using the JavaScript programming language, which is built into most web browsers. JavaScript interacts with HTML using something called the Document Object Model (DOM), wherein the JavaScript can pull references to objects in the HTML and store these references in DOM variables and the JavaScript program can manipulate the DOM objects in the HTML by manipulating the variables which store the DOM object references.

Additionally, HTML has form elements which enable a user to input data. When the form submit command is triggered, the data entered on the form is processed, either by a client-side program, or by the data being sent through the internet to the web server to be processed by a server-side script. Form input elements include elements to input text, elements to upload files from the user's computer or device to the server, and drop-down lists that enable the user to select an item from among a list of predetermined items. HTML also has list tags which format content into a list of items, and HTML lists can be either numerically ordered or unordered. And HTML has a table feature using table tags which format content items into a table of cells arranged in rows and columns.

HTML5, which was released in 2014 and is gradually being adopted, has added new features that are implemented by most contemporary web browsers. These features include videos served using the video tag, audio files served using the audio tag, dynamic visual content served using the canvas tag, and animations using CSS3, which is the new version of CSS that is associated with the new HTML5. The canvas tag displays an image or an animation that is generated dynamically by a client-side program, typically written in JavaScript. The canvas can output text, an image, lines and shapes, or can move through a series of images or lines and shapes to create an animation. CSS3 has features which, although not implemented on all browsers, enable animation of elements on a web page, such as text changing colors. CSS3 also has robust implementation of borders, such that an item on a web page can be given a border, such as a blue rectangle around it.

HTML and HTML5 enable the use of div tags and span tags. This div and span tags are logical elements, meaning that their only use is to apportion and identify a specific section of a web page so that other programs, like CSS and JavaScript, can act specifically on the content in that section. Div and span differ only in that div is used for block-level elements, in other words paragraphs or sections that stand on their own, while span is used for inline elements, in other words to specify a series of words from within a longer sentence or paragraph. HTML elements, including div and span, can be given named IDs or named classes. A class is used by CSS or JavaScript (through DOM) to identify a group of elements. A named ID is used by CSS or JavaScript (through DOM) to identify individual elements. For example, if a span is named span23, JavaScript could use the DOM to identify that span on the web page and could then add client-side program functionality, such as by calling a function when the user clicks on the words in the section identified by the span named span23.

A client-side program runs on a web browser while a server-side script runs on a web server. A programming technique called AJAX enables communication between these two sides, wherein an AJAX call by the client-side program sends a data file to a server-side script such as a PHP page. The data file can be in several formats, one of which is JSON, which is an array of name-value pairs. A server-side script is typically able to write data to a data server connected to the web server, for example by a PHP script saving data to an SQL database.

In one embodiment, the software is an electronic document creator that enables users to create and edit electronic documents via web page inputs, to code and store said electronic documents using the Blackjack document format and to display said electronic documents as web pages. A Blackjack document is a document composed of a series of electronic document parts where each part is selected from a list of twenty-one parts types and each part of a specific type has a predetermined size and specific details regarding its content and styling and input and output. Of the twenty-one document parts types, nine can be categorized as word processor parts, four can be categorized as spreadsheet parts, and eight can be categorized as presentation parts. The Blackjack document format is a new, original element of the embodiments.

The unique combination of parts in the Blackjack format gives the user a full complement of features for electronic documents outputted as web pages in HTML5, including video through video tags, animation through canvas tags, spreadsheets using table tags, and text using CSS for styling such as bold face, italics, and font size. In one embodiment, the list of twenty-one document parts types includes text, lists, tables, fillable forms, headings, links, bookmarks, page break parts, tables of contents. Spreadsheets include tables of data, math operations that can be applied to data, logic operations that can be applied to data, and spreadsheet templates. Presentation parts include videos, audio files, images, CSS3 animations, canvas images, canvas animations, canvas graphs, and canvas graph animations.

In one embodiment, a user logs into a session of the electronic document creator from a web browser. The electronic document creator is a web application that lives on a web server as a server-side script. The electronic document creator offers the user the option to create a new document of the Blackjack document format. The user selects to create a new document. The electronic document creator then gives the user the option to create a new electronic document part in the electronic document. The user selects this option and then selects a part type from a drop-down list listing twenty-one parts types. Based on the parts type selection, the user is given an HTML input form field or set of fields.

The details can be subcategorized as to whether the part type is a word processor part, spreadsheet part, or presentation part. For many parts types, the user enters data via at least one or more fields in an HTML input form and the user then selects items in the text using the Text Word Object Model (TWOM), a new model unique to the embodiments in which input is parsed into items (i.e. words) and each item is given a named span ID and the DOM is then used to create a DOM event such as click or touch event for each item so that when the content is outputted as a web page the user can select an item by clicking it and/or touching it.

One embodiment uses CSS classes to apply styling to text in word processor parts. In one embodiment, the content is outputted as HTML in one section of the web page for the user to click items to select them while editing and styling options for selected items are outputted in a menu in a substantially adjacent section of the web page.

In one embodiment, a user selects an already-existing part to edit by flipping through pages to find the target part and then clicking on the target part. Because in the normal “edit mode” clicking on a part or word opens it for editing and a user may want to move through text to read it without editing it and may need to touch it on a smartphone to move around to read it, the user can select a command to enter “read mode”, wherein all input events and event listeners are turned off. While in read mode the user may select “edit mode” which restores all input events and event listeners to active status.

In one embodiment, a robust package of mathematical operations and logical operations are available to be applied to data in the spreadsheet parts, and said operations can be combined by users into customizable formulas which can be applied to data in spreadsheet cells. In one embodiment spreadsheet cells and math and logic operations are selected using TWOM. The precise profile of math and logic operations available in the embodiments is unique to the embodiments, especially because some of the logic operations are novel.

In one embodiment, data can be translated from spreadsheet cells to presentations using the software. In one embodiment, animations can be constructed by the user by choosing or creating a series of goal states and then having the program create animations that go from one goal state to another goal state. For example a CSS3 animation where text moves from left to right, or a canvas animation where a bar graph grows through 12 different stages to represent the growth of profits over 12 one-month periods. In one embodiment, the user who uses the electronic document to give a presentation can specify the parts on each page and the positioning of parts on a page in advance, and at the time of the presentation can enter commands to flip from one page to the next page, and each animation plays when the page for that part is loaded into the web browser. It is also possible to have a dynamic canvas animation part and a video or audio part as two parts on one page, such that an animation can play side by side with audio or video commentary to narrate it. Thus, the presentation feature is based on parts and pages, not on slides as in traditional slideshow presentation software.

In one embodiment, because each part has a predetermined size which is designed to be small enough for a user to easily manipulate one part on a small smartphone touchscreen, documents are divided into pages through a process where a predetermined number is the pagination number and there are that number of parts on each one page. In one embodiment, the pagination number is four, and there are four parts per page. However, this disclosure is not intended to be limiting, and the pagination number in other embodiments could be five, ten, or any other reasonable number.

In one embodiment, positional CSS can be used by the user to rearrange the positioning of the four parts on each one page. In one embodiment the user can select prebuilt page layout templates which arrange parts on page for output. In one embodiment, each part is assigned a sequence number, wherein said sequence number is initially assigned automatically to a newly saved part to be the number that is the prior most recent part's sequence number plus one, but the user can change a part's sequence number manually. Parts output in a document in order of their sequence number, e.g. part #1 is first, part #2 is second, part #3 is third, etc. In one embodiment, parts are assigned to pages by their sequence number, e.g. Parts #1, 2, 3, and 4 are on page #1, Parts #5, 6, 7 and 8 are on page #2, etc. In a different embodiment, the user manually selects the page that each part is assigned to. In one embodiment, the document creator can process a set of data comprised of the pagination number and the sequence numbers of all parts in the document to identify which page each part should be assigned to. In one embodiment this is done by counting through parts by a number equal to the pagination number, for example, the software would count 4 twice to reach number 5 so the part with sequence number 5 is on page 2.

In one embodiment, one part may only be edited by one specific user at one time but multiple users may edit different document parts in the same document at once. Thus, the parts architecture solves the problem of organizing simultaneous collaboration without one user stepping on another user's toes. Also, in one embodiment a part has one data storage location in one database, and every web page output of that part comes from that the data stored in that one data storage location. This solves two problems, first, the problem of different versions of documents causing users to not know which is the current version where office productivity software enables multiple user editing and collaboration, and second, the problem of different saved versions of the same files floating around.

In one embodiment, the user begins by logging into a session on the server for the document creator program. This brings up the option to start a new document or work on an already existing document. If the user selects the new document command, then a new document opens, which creates a data table for the document on the SQL data server. The user is then given the option to start a new document part, and the user is given a drop-down list to select which part type for the new part. When a new part is opened the specific details of the software logic vary based on the part type. In general, one part is processed by the client-side program at one time, so that in order to work on a different part, the last part must be given a final save or a delete to open up the working space for the new part. Once a part is created or edited, it is given a final save command. This sends the part from the client-side program to the server-side script, which processes it and saves it in the SQL database. If the part includes an image, video file, or audio file, the server-side script also processes and saves it at this point in the software logic.

There is a button to do a final save and then return to the menu to select a new part or select a different part to edit, and also a button that is a shortcut to do a final save for this part and immediately open a new part that is the same part type as the previous part with a sequence number that is one higher than the previous part. For example, in a document with mainly word processor parts, each paragraph is a new part so the user wants to easily be able to input paragraph after paragraph. There is no command to save the document separate from the individual commands to save document parts because the saved document is merely the sum of all official saved document parts.

If the user does a final save and returns to the menu then he has the option to create a new part of any type or select a different already existing part to edit or to create a new document or work on a different already existing document. If the user selects to work on a different document he is given a list of documents he has editing access to, and selects a document to open it. If he selects to work on a different part in the same document then he is given the document output of one document page as a web page, one page at a time, and he can flip through the pages using next page and previous page commands, and select a part by clicking it, or he can opt to create a table of contents part and then select a part through the table of contents.

At any time the user may select to exit the program or to output the document that he is working on or to output a document that he has permission to output. When the user selects to output a document he selects options from a drop-down list. The user may output the entire document as one long web page with the page break part in between each page, he may output the document as a series of web pages with one document page per web page and forward/back buttons to flip between pages, or he may output the document one part at a time on a mobile device, or he may output the document as a table of contents part with links to go to the various target parts, or he may output the document as a web page or web pages specially formatted to be printable, or he may opt to output it as an SQL script to recreate the SQL database that stores the official document, or he may use third-party software to convert the document to a different format for output. Most web browsers have the native ability to save a web page or print a web page for the web page currently loaded in the web browser, so if the document is outputted as a web page or web pages then the user may use the browser to save the page to his local computer memory or to print the page from the browser to his local printer.

For a word processor text part, the program logic works as follows: if the user selects to create the part then the user is given a text input box HTML form field. In one embodiment the text input box is a text area type HTML form input with a 1,400 character maximum limit. In one embodiment the maximum character limit is 800 characters. Other embodiments could have different character limits, or no character limit. This text can include letters, numbers, spaces, hyphens, and any symbol supported by the keyboard or smartphone text input and character encoding system, such as UTF-8. The web page also contains a named div and in this div there are a set of named empty spans. In one embodiment, where 1,400 characters could be entered, there are 300 spans. In one embodiment, where 800 characters could be entered, there are 200 spans. In other embodiments the number of named spans differs.

The user, after entering the text, clicks a “process” command. The initial process command sends the inputted data as a text string to the client-side program. The client-side program than processes the text string using the Text Word Object Model (TWOM), which is a novel aspect of this embodiment. The TWOM function first accesses the div and all spans in the div by means of the name IDs of the div and the spans and assigns each named div and span through the Document Object Model (DOM) to a set of named variables. In one embodiment, where there are 300 spans, the spans are named “1,” “2, “3,” etc., and the variables are named span1, span2, span3, etc. In the embodiment with 300 spans the user is limited to 300 words per part, and in the embodiment with 200 spans the user is limited to 200 words per part, etc.

The TWOM function then takes the input as a text string. It strips all computer code out of the text input to block code injection attacks, and it next parses the text string by creating a variable array and then analyzes the text string. In one embodiment this analysis is comprised of using the JavaScript text string object's slice method and feeding the slice method an end-of-word character as a parameter and assigning the method to an array. In one embodiment the end-of-word character is a space. The result of this is that the slice method identifies each substring within the text string that is surrounded by spaces, which generally would be each word, and assigns each word in numerical order to the array with the index of the array being the number of the word in the text string. Note that an array is a set of variables, so a set of predefined named variables can be used in a manner functionally identical to using an array of variables.

In one embodiment the TWOM function then outputs the words in the array to the web page by outputting each word as HTML to a named span through that span's DOM variable. In one embodiment this is done using the innerHTML method of the DOM object. In another embodiment this is done using the html feature of a jQuery DOM node. In one embodiment all the spans are within both a named div and a paragraph tag. In one embodiment the TWOM function uses the span DOM objects through JavaScript to create input DOM events for each named span. In one embodiment the event is a click event. In one embodiment both a click event and a touch event is created for each object. In one embodiment this is done by coding an event listener in JavaScript. In another embodiment the j Query DOM node is used to create DOM events for the nodes. In one embodiment there are 200 or 300 lines of code in the client-side source code, one for each span, which accomplishes these results. In another embodiment a loop with 200 or 300 iterations for each span, such as a for loop, loops through each span to accomplish these results.

In one embodiment style options are outputted side by side with the named spans. For example, a drop down list of options that include highlight, bold, underline, italics, etc. is displayed, and one option in the list is selected. The user triggering the input event for a TWOM word applies the selected style editing option to that word. What this means is that when the user clicks a word with a mouse or touches a word on a smartphone touchscreen, the client-side program will register an event keyed to that unique span name for that word. In a different embodiment, the style options are not immediately present, but when the user selects a word this causes a list of styling options to display in a menu substantially adjacent to the content display. If the user clicks a word and then clicks bold or italic or change font or change color then the program will dynamically keep a record of the CSS rules value associated with that word, where that CSS name refers to a set of CSS rules that the program has set as available for text. The program maintains a style sheet with a set of prebuilt text styling classes, and the CSS identifier associated with a word identifies the CSS rules that apply to that word. For example, a word may have a CSS value identifier of “24,” which identifies, for example, a set of CSS styles of italics plus red font on a black background.

In addition to clicking a word to select that word, other selection options exist in some embodiments. The user can enter an input event for a “click to select a sentence” command, then enter an input event for one word, then enter an input event for a second word, and the program will identify the events for both words and then select those two words plus all words between them. In one embodiment this is done by collecting the names of all the spans for that set of words.

In one embodiment the user can also click a “select by selector” command. This command selects items in the content one by one and uses the named span in combination with a CSS rule to wrap a colored border around the word item so that the user can see which word is selected. The selector is moved by right and left directional arrows on a keyboard if run through a laptop or by displaying buttons in a smartphone touchscreen including left, and right, which buttons are tied to input events through DOM. In one embodiment the selector can move left and right through the text content, selecting one word item, and it keeps a variable with the numerical name of the selected span, which goes up by one on an input event to go right and goes down by one on an input event to move left. A button is displayed which on the button event opens the styling menu for the selected word item. In one embodiment the select a sentence and select by selector can be combined so that when two words are selected one after the other the sentence composed of those two words plus all words between them opens.

In one embodiment, the user is also given an option to apply a CSS style to the entire part, which is applied through the named div that the part content is wrapped within. In one embodiment, a CSS style selector is shown on any word that is selected to show the user which word he has selected. In one embodiment a selector comprised of a visible CSS style applies to each part and each item within the part that is selected, for all twenty-one parts types. In one embodiment the CSS selector is a CSS border. In one embodiment the CSS selector is a background color not available as a normal background color in the program.

In one embodiment when a word or sentence is selected an “edit text” button exists on the styling options menu. Clicking this has a result that the text is then loaded as default text into a new text input form field. The user can then change the text and click the save button. This then leads back to the same program logic that exists after a new text content is saved. In one embodiment, when text is reedited all styling identifiers are stripped so the styling is lost and must be reentered. All words in reentered text are treated as new words and are reparsed and given new span ID names. In another embodiment, unusual text characters are outputted to indicate the presence of styles, and these text characters are interpreted by the TWOM function to indicate styles. For example, “The cow &&&jumped&&& over the Moon” would be outputted to indicate that the word “jumped” is underlined, and when the text is re-inputted to TWOM, that word would be styled with CSS underlining. The user can delete or move the “&&&” or other special characters in the text input field to dynamically change the text styling.

In one embodiment, when the “edit text” command is entered the program collects the span numerical name of the word immediately preceding the first new word, and when the new text is reparsed the first word in the new text is assigned to the next subsequence span number name and all subsequence numbers proceed from that number, with all remaining words in the text reassigned to new numbers to match the number sequence so that the first word is 1, the last word is 300, etc. In one embodiment a “delete” button can delete selected text within a text part, in which case the remaining text words are renumbered similar to the edit text renumbering.

Once the user finishes work on the electronic document part, he inputs a final save command which causes the client-side program to send the data comprising the part content and style to the server, which processes the data and stores it in a record in an SQL database for that document. In one embodiment the client-side program sends the data by sending an array which is a set of the names of the spans and the value of the word associated with the span, and because the span name is also the number of that word in the part, e.g. “1” is the name of the first span, this array is at the same time a numerically indexed array of the words in correct order. In one embodiment the client-side program also sends a second array which is a set of pairs of numbers and values where the number is the identifier of the word and the value is the identifier of the set of CSS rules to be applied to that word. In one embodiment the CSS array also has one value which is the CSS for the entire text of that part. In one embodiment the 300 words are stored in one content field in the SQL record. In one embodiment there is one content record to hold words and one content record to hold style information for the words. In one embodiment there are at least 300 fields in one SQL record and one word each goes into one field. In one embodiment one record has at least 600 fields comprised of 300 fields for words and 300 fields to hold values indicating the style for each word where one field holds style information for one word with a number in the order of style fields corresponding to that word's order in the number of word fields. For example, if there are 300 words per part, field 301 holds style data for the word in field 1.

At this point in the program logic the user may elect to retain editing access to that part, pass editing access to a different user, or let the program perform its default behavior (which is to let the user who created the part retain editing access). One part may only be edited by one user at once, and the user with editing privileges is referred to as having editing access for that part.

The SQL record then becomes the official document part, which can be viewed, shared via a link to it, or it can be reopened by the user who has editing access for that part to be reedited before being final saved again. Prior to the final save the user may select to assign a sequence number to the part, which would place the part in a specific place within the sequence of parts in the document, or he may elect to use the default, which places this document at one sequence number higher than the previous part which was final saved by that user in that document.

CSS3 styles that can be applied to the text part types include italic, bold, various common font families, various common font sizes, various common text colors, various common background colors, various text color/background color sets, centered text alignment, line height/double spacing, underline, strikethrough, text shadow, blink, text alignment that is left justified, text alignment that is right justified, font variant small caps, text transform upper case, text transform capitalized, text transform lower case, wide letter spacing for increased space between letters, and wide word spacing for increased space between words. In one embodiment there are maximum limits on font size and spacing options to create a maximum total limit to the potential size of a word processor text part displayed output so that a set of parts will always fit comfortably on one output web page. In one embodiment there is a broad list of prebuilt CSS sets of style rules, for example bold italic red font on black background large font size, and the user may only select from this list of prebuilt CSS sets to apply styles to text.

For a word processor list part, the list is outputted using HTML list tags as either an unordered list, which is typically indented and bulleted, or an ordered list, which is typically numbered. The tags used are, for example,

```
<ul>
      <li>Text item in the unordered list</li>
      <li>Next item</li>
</ul>, or
<ol>
      <li>First item in the ordered list </li>
      <li>Second item</li>
</ol>.
```

When a user selects a word processor list part type as the part type to create, the program logic works as follows: the user selects the number of items in the list from a drop-down menu wherein the highest number on the list is a limit to the maximum size of a list part, the user selects a bullet-point list or a numbered list from a drop-down menu, the program generates a list where each item is a form text input field, the user enters text into the fields in the list, the user selects a command to save, the program generates a list of the kind selected where each inputted value becomes the list item in that place where it was in the list of input fields, each list item is given a named span and a DOM input event using TWOM, the list is displayed, the user then selects a style option from a menu of CSS styles for the list item, the user selects a list item to style using TWOM, the user has the option of clicking a command to add a new list item to the bottom of the list which creates a new form text input which the user can enter a text string into and click a command to save it which adds it to the bottom of the list and processes it using TWOM, the user clicks a command for final save, and the part's list items are placed in an array and sent to the server which then saves it to the SQL record for that part as an official part. In one embodiment ten is the maximum number of list items that can be in one list part, so a longer list requires creating a series of parts.

For a word processor table of text, the table is outputted using the HTML table tag, which is coded using a series of table data cells that are placed in table rows where the table is a series of table rows. The code looks like, for example,

```
<table>
      <tr>
            <td>upper left text cell, i.e. row 1 column 1</td>
            <td>upper right text cell, i.e. row 1 column 2</td>
      </tr>
      <tr>
            <td>lower left text cell, i.e. row 2 column 1</td>
            <td>lower right text cell, i.e. row 2 column 2</td>
      </tr>
</table>
```

The interesting thing about HTML tables is that the data is not entered in a specific cell location in the table, rather the table calculates the cell location by finding the column for a cell based on the number of table data cells in each row prior to that cell (e.g. the fifth data in a row is in column five) and then finds the row for a cell by calculating the total number of rows prior to that row (e.g. the row with three rows above it is the fourth row). Thus, for software to use HTML tables, it cannot simply define the cell that it wants a data entry to go into, instead it must be aware of the total number of rows and data entries prior to each cell in order to line up the cells properly and put the correct data into the correct cell location. The problem of the software keeping track of row and column locations is solved using a function which keeps a record of variables that correspond to cells so that it can match the value in a given variable to the value in a specific cell.

In one embodiment, a word processor table always has five rows and five columns for a total of twenty-five cells. In one embodiment tables have ten rows and ten columns and one hundred cells. In one embodiment the user may select a 25 cell table or a 100 cell table. In one embodiment the 25 cell table uses an HTML template with a twenty-five cell table code snippet that is already coded. The word processor table of text part works somewhat like the list part, in the sense that the user selects to create a word processor table of text, the software then generates a table where each cell is a text input form field, the user enters values into the cells, the user selects a save command, and the software generates a table that has the entered values in the cell on the output table that corresponds to the location of the cell in the input table where it was inputted. If a cell is left blank in the input table then it is left empty in the output table.

The software logic works because each input cell is assigned a variable with a name that matches its position in the five by five grid, so the software knows which cell that data is for by the named variable that the input goes into, and it then uses the variable name to match that data to the right output cell. In one embodiment, the data variables are named with X and Y values representing the cell location. For example, the input table cell that is on the second row up from the bottom and the third column to the right of the leftmost edge is considered to have a location of (x=three; y=two). In one embodiment the text input form field at that cell is named XThreeYTwo. In one embodiment the table is an array with twenty-five members, so that the cell variable is TwentyFive[8], because it is the eighth cell counting up and right from the bottom-left corner. When the HTML output is created it is then inserted into the cell in an HTML table template, which has that cell's value taken from the variable being interpolated into the cell in the table that is three over and two up from the lower-left corner.

Because the part always has a table that has twenty-five cells in five rows of five columns (or 10 rows and 10 columns in a 100 cell embodiment, or however many rows and columns make the predetermined number of cells in one table), one embodiment uses a template to output the table for every table part, and it is possible to use the same set of twenty-five variables and names for the twenty-five cell locations with only the value in each variable changing for each individual inputted table part.

Note that an HTML template is a piece of HTML code which contains an HTML structure that variables can be inserted into to flesh it out. One embodiment uses an HTML template of a table with twenty-five cells and then adds twenty-five variables into the template to fill it to form the final HTML output to display. The different values in the same cell location in different parts, for example cell X1Y1 in Part 5 and cell X1Y1 in Part 6, are distinguished in the software logic by the different part IDs in the database, and also by the different sequence identifiers that are different for each different part.

For a word processor fillable form or template part, the program logic works as follows: the user creates a text part using the logic design similar to a word processor text part. The user then clicks or touches a word in the text to select a place to insert a form text input field, and this place is identified by the software using the TWOM DOM event for the word the user selected, with the place being the first space beyond the selected word. The user is then given a menu of drop-down lists to select properties of the form text input field, specifically whether it is for one word or one sentence, or one block of text. The user clicks a finish command and the software then modifies the content to add the HTML code for a form text input field at the location in the HTML that corresponds to the selected place. The input field is assigned an ID and the program creates a variable to hold the value from the form field when the form is submitted. The user then repeats this process until all desired form text inputs are added or until a predetermined number of text inputs is added, which serves as a maximum number to limit the total size of the part. In one embodiment a limit of five text inputs and two text area inputs per one word processor form part is imposed upon the user.

Once the form is built the user clicks a final save command which sends the data to the server to become an official part in the document's SQL database. In one embodiment each word is stored in an array and each text input in the form is recorded as one item in the array, and in another embodiment each word is stored in a variable in a set of variables. The user can then open the part, which then displays the text with the form fields in it.

Then, if a user inserts text into the form fields, there is a “process” button which the user can click. When the user enters data into the form fields and clicks the process command the program submits the HTML form with the text typed into the form fields to the client-side program for processing, and the client-side program collects each field input from the ID into the associated variable and then creates a new word processor text part consisting of the text in the form plus the inputted values which are printed into the areas where the text input fields were where those inputted values were entered. In other words, the process command converts the text form part plus the inputted text into a new text part. This newly created text part can be placed in the current document or can be saved in a new document.

The option to save in the current document or in a new document is a preexisting setting that the user can change in the settings menu, and the default is to save a processed new part in a new document. In one embodiment the program converts the premade text plus the inputted text into a series of words using a TWOM method and then outputs the words into a series of spans in the output HTML.

A small text input form field for a word or sentence can be coded as, for example:

<form><input type=“text” id=“smallTextVariableNameOne”/></form>.

A text block input field can be coded as, for example:

<form><textarea id=“bigTextVariableNameTwo” rows=“5” cols=“40”></textarea></form>.

For example, assume that the form part is “The Company named (text input field) hereby agrees to enter into a contract for shipping and delivery of the Company's products within the state of (text input field) to deliver the Company's products to customers by means of delivery trucks and vans.” The form part HTML will contain the text and a form input where the text input field is, which is given an id, for example, smallTextVar1 and smallTextVar2.

The process command submits the form to a client-side program which takes the input from smallTextVar1 and stores it in a variable called smallTextVar1, and does so for all other variables similarly. Say, for example, that this input consists of first “Acme Fireworks, Inc.” and second “Connecticut.” The program has a set of variables, possibly in an array, of the prebuilt words in a series with a variable placeholder where every text input in the part is. The program upon the process command then adds the inputted values in the placeholder places in the variables. This then results in variables containing words that form a sentence that can be outputted as HTML through a series of TWOM named spans.

The resultant output is “The Company named Acme Fireworks, Inc. hereby agrees to enter into a contract for shipping and delivery of the Company's products within the state of Connecticut to deliver the Company's products to customers by means of delivery trucks and vans.” This then at this point becomes a regular text part, no longer a text form part, because the form fields were filled in with text and saved.

For a word processor title or heading, the software logic works the same as for a word text part except that there is a smaller maximum character entry limit and a bigger default font size and a bigger maximum font size. In one embodiment, up to 300 characters may be entered into one heading part. In one embodiment, a title or heading is also automatically turned into a bookmark part so that it will show up in a bookmark-based table of contents part.

For a word processor link part, in one embodiment the software logic works as follows: the user selects to create a link part, the user selects from a drop-down menu whether to link to an external web page or an internal bookmark in the document. If the user selects to link to a web page, the program gives the user a form input field or HTML5 URL-type input field, the user types in a URL (Uniform Resource Locator), e.g. “www.example.com/notarealpage” and the program collects the data from the form field into a variable and interpolates that variable into the href attribute of an anchor tag to create a link. In one embodiment the form field is a standard text input field and in one embodiment the form field is an HTML5 URL field, which automatically opens special features in the web browser for selecting URLs and validates the text for correct URL format if the browser supports the HTML5 tag.

If the user selects to link to a bookmark then the user is given a list of all bookmarks in the current document, the user clicks a bookmark, and the software then creates an anchor tag linking to that bookmark. For example, if the bookmark is a div id=“BookmarkOne” then the program creates an HTML code snippet that says: <a href=“#BookmarkOne”>Link to Bookmark One</a>. In one embodiment, the link to an internal bookmark will be a dynamic link that will pass the bookmark part sequence number to the program and call a request for the page containing that part. In one embodiment, the default font size for a link is large, to make it easy to click and so that four link parts would substantially fill up a page.

For a word processor bookmark part, the disclosure must begin with background regarding the meaning of the term “bookmark” in the context of web development. A bookmark can mean one of two different things. A bookmark in a web browser is created by the web browser, typically be choosing a “bookmark this page” command when a specific web page is loaded into the web browser. Such a browser bookmark will then navigate to the bookmarked page when the bookmark is selected from the user's list of bookmarks. In contrast, a bookmark in a web page is a specific place in the web page that has specific HTML bookmark code inserted at that place. A different place in that web page can contain an HTML link to the bookmark, which when the link is clicked causes the browser to go to that place in the web page. In summary, browser bookmarks load a bookmarked web page while page bookmarks go to a specific place on a page.

In one embodiment, a bookmark part can be used as both a page bookmark and a browser bookmark. In one embodiment, the bookmark part is coded as a div with a specific div ID and which contains negligible filler content or which is left empty. Links parts linking to the bookmark part as a page bookmark then are coded as anchor tags with the div ID as the href attribute.

However, page bookmarks will only work when the link and the bookmark are on the same page, either the same document page or when the document is outputted as one long web page. In one embodiment, for clicking a link part to the bookmark part to open a different document page containing that bookmark, when the bookmark is saved as an official part in the SQL database the database record includes the bookmark's sequence number. When a link to the bookmark is clicked it runs a function that checks to see if the bookmark is on a different page, and, if so, it queries the SQL database for the page that contains the bookmark and then outputs that page and then executes a link to go to the place on that page containing that bookmark.

It makes sense to mention here that in one embodiment the URL scheme of the output document pages is such that the user can use his web browser's native bookmarking feature to create browser bookmarks for pages because the page URL is stable, in other words a “permalink”, while in another embodiment the page URL is dynamic and in another embodiment pages load through AJAX so that different pages display as sections of one page with one URL, and in these latter two embodiments the web browser's native bookmarks feature would not work for pages because each page would not have a stable unique permalink URL.

In one embodiment, the software is run on the client company's internal server and stored on the company's data server, and in another embodiment the software is run off a cloud server and sold as software-as-a-service. For example, if the software is run off the client's server and static URLs are used, the URL for page number fifty of the document named ShippingContract23 made by Generic Company could be www.generic.com/wordprocessor/shippingcontract23/page50.html. When the user is on this page and he clicks his browser's native bookmark this page command, the browser will save that URL, which will always go to that page. That bookmark is in the web browser itself, not in the word processor software, and, in terms of the code, that bookmark is external to the embodiment itself and is not considered to be a bookmark part created by the electronic document creator software.

However, in another embodiment, the URL for the page is a GET command which sends a GET request to the server to dynamically generate the page by pulling page content from the SQL database and using that page content to dynamically create the page HTML. For example, the URL could be www.generic.com/wordprocessor?doc=23&page=50. This would serve as a permalink despite being dynamic in the content it actually pulls.

In another embodiment, the only URL is www.generic.com/wordprocessor, and all pages are loaded into that page template using AJAX calls sending POST data to the server to tell the server which page to send and loading the page data sent by the server into an output display section of the home page. This would pose a challenge for a browser-based bookmark.

For a word processor page break or header or footer part (these three all being one part type), the user selects to create the page break or header or footer part, the user is given a drop-down list to select page break or header or footer, and the user is given a text input that works like a word processor text part, but with a smaller maximum character limit.

In one embodiment, the limit is 300 characters. In one embodiment, the styling menu includes buttons to insert the document title, the page number of the current page, the total number of pages, which when inserted are stored as variables that dynamically update if the title changes or when the variable is on a different page or when the total page count changes. If the user selects footer then the part is appended to the bottom of each displayed page. If the user selects header then the part is displayed at the top of each outputted page. If the user selects page break then the part is included at the top or bottom of each individually outputted page and is included between each page if the document is outputted as one long web page. In one embodiment this means that the page break is inserted between every group of four parts assuming that a pagination number of four was used. In one embodiment a page break part is positioned as a footer if pages are outputted as a series of single pages. In one embodiment the page break part is not counted as a part by the pagination algorithm that assigns parts to pages, and one page break part is displayed on every page, or on every set of pages that it is assigned to.

For a word processor table of contents part, the user selects to create a table of contents part. The program gives the user a drop-down list to select from the following options: a bookmarks-based table of contents, a table of contents for all parts, a table of contents for sections and chapters, or a table of contents based on a search.

If the user selects a table of contents based on bookmarks, the program reads the SQL database to identify every bookmark part and then auto-generates a list of links where each link links to one bookmark. If the bookmark is on the same page as the table of contents then the link goes to the bookmark location, and if the bookmark is on a different page then the link opens the page containing the bookmark.

If the user selects a table of contents of all parts then the program analyzes the sequence table in the SQL database and auto-generates a list of links where each link links to one part and the links go in order of part sequence numbers. In one embodiment, each link contains identifying text that identifies the part. In one embodiment, the identifying text is a set of the first words or sentence in the text of a word processor part or presentation part and the first five or ten cell values of a spreadsheet part plus the part's sequence number.

In one embodiment in the settings menu the user may select that table of contents links to bookmarks or parts on other pages open the new page in a new browser tab or in a new window. If one of those options is selected, the table of contents and the newly opened page are both accessible through the browser at the same time. In one embodiment the program uses the anchor tag's target attribute to cause the new output page to open in a new window or tab in the web browser.

In one embodiment the user has the option to assign a part to a section, which is an arbitrary grouping of parts, either contiguous, in which all parts in a section follow one another in sequence, or dispersed, in which parts out of order are in one section. In one embodiment a user has the option to assign pages to chapters, which are arbitrary groupings of pages, which are also contiguous or dispersed.

In one embodiment when a part is open a user may assign it to a section, or the user may first create a new section and then assign a part to a section. In one embodiment when a user is viewing a page the user may assign it to a chapter, or the user may first create a chapter and then assign a page to a chapter.

In one embodiment, if the user selects a section and chapter table of contents then the program auto-generates a list of links to the first part in each section and the first page in each chapter and places identifying text in the link. In one embodiment, the identifying text for a section is the first ten words or data values from the part and the part's sequence number, and the identifying text for a chapter is the first page number plus the first ten words or data values in the chapter. In one embodiment, the user from the table of contents may select to see a table of contents of parts and a table of contents of sections and may select parts and assign them to a section by clicking on a section from the table of contents list of sections and then by clicking on identifying text of parts in the table of contents list of parts. In one embodiment, in the table of contents part menu an option exists to open a field whereby the user can input a name for a chapter and then input a range of numbers, and then the page numbers for that range of numbers are assigned to a chapter with that name.

In one embodiment the program's search feature and find plus replace feature are available in the table of contents part menu. First the user selects search or find plus replace from a drop-down menu. Both commands begin by displaying a form text input field for the user to input the target value. The user inputs the target value and then clicks a process command. The program then pulls all content fields from all parts in the order of their sequence numbers and searches content fields for the target value. The search function searches a part by identifying the part type by its ID number in the SQL records and then searches the content for the target value. For example, the search function would search a series of words in a content of a word processor text part content and would search a series of data values in a spreadsheet part or would search the name of a file in a video part. The search function forms an internal list of search target hits.

The search feature then creates a table of contents of links where each link goes to the part containing the target value. In one embodiment the program then goes to the target value's location in the part containing the target value. The link in the search table of contents contains identifying text comprised of the target value at it exists in the found part plus words and data values that follow the target value in the found part until a limit of a number, which in some embodiments is five or ten words or data values, is reached.

The find plus replace feature works like the search feature except that the user enters a replace value as well as a search value, and the program when it finds the target value deletes it and inserts the replace value in the location where the search value was, and then displays a find and replace table of contents that links to each part where the replace value replaced the search value.

In one embodiment, substantially adjacent to the search command and the find plus replace command is a spell check command which causes the server to compare each word to an external database of correctly spelled words. The spell check command then outputs a display substantially similar to the search-based table of contents except that it is a list of misspelled words with links to each location of a misspelled word. The user can then navigate to all instances where the spell checker believes that a word was misspelled and the user can decide whether the word is correct or not and can manually edit and change the word if necessary. In one embodiment, the spell check command opens a drop-down menu enabling the user to select whether to spell check the current part, the current page, a range of pages, sections or chapters, or the entire document.

For a spreadsheet table of cells part, it is necessary to explain that in one embodiment the spreadsheet does not work precisely the same way that convention spreadsheets work. Each spreadsheet part is a table of cells comprised of a set number of rows and columns, which in one embodiment is five rows and five columns for a total of twenty five cells, although this is not intended to be limiting and other embodiments have different predetermined numbers. The cells are numbered using an x y coordinate system modeled on a Cartesian plane, with the origin at the lower left corner. Thus, the columns are numbered from left to right x1, x2, x3, x4, x5, and the rows are numbered from bottom to top y1, y2, y3, y4, y5. An example cell can be identified as (x=3, y=2). Each spreadsheet part is outputted and saved using a premade HTML table template with five rows and five columns and the program uses twenty five variables to hold the data values of the twenty five cells. In one embodiment the data is stored as one array with twenty five data items in the array.

Each spreadsheet part also has a twenty-sixth value called z, which is the way that the program and a user can combine multiple spreadsheet parts into a larger collection of spreadsheets. In one embodiment, each spreadsheet part has a z value and the z value is numbered one, two, three, etc., with the spreadsheet part with the lowest sequence number have a z value of zero, the next sequence number having a z value of one, and the next of two, then three, etc. In another embodiment, the spreadsheet part that is first created in a document has a z value of zero, the spreadsheet part created second has a z value of one, the spreadsheet part created next has a z value of the prior spreadsheet part plus one, etc., regardless of the sequence numbers of the parts. In this way, in one document, every cell in every spreadsheet can be referenced by an (x, y, z) coordinate value.

This is not precisely the same thing as a multidimensional spreadsheet, because z refers merely to a spreadsheet part, and there is no actual three-dimensional coordinate space that the cells are mapped to, and x and y are capped at five and the z is capped at the number of spreadsheets and actually refers to parts not cells, such that z refers to a part and x, y then refer to a cell in that part. There is a limit to the number of rows and columns (which in an embodiment is five) but no theoretical limit exists to the number of cells in a chain because the z value can extend infinitely and a cell in one spreadsheet part with one z value may refer to a cell in a different spreadsheet part with a different z value.

One difference between the embodiments and the prior art is that an embodiment does not use true multidimensional coordinates nor an infinite x and y axis. Another difference is how math operations (and logic operations) are performed on data using the spreadsheet. In a conventional spreadsheet, the cells contain number values, text values, and references from dependent cells to other source cells, and one cell can contain a math equation applied to another cell. In this way, formulas are stored in cells in the conventional spreadsheet. One embodiment of the invention stores data in the cells in a spreadsheet and separates out the actual mathematical operations, including operations chained together into a formula, into a different part, which is the math operations part. There is also a logic operations part. If a formula contains a chain of math (and/or logic) operations and the variables in the formula are assigned specific locations in the spreadsheet, then it becomes a spreadsheet template part.

An example will clarify how the embodiments operate. In one embodiment, the user selects to create a spreadsheet part. This displays a twenty-five cell table where each cell contains a form input field. The user enters values into at least one or more cells and then clicks a “process” command. This causes the program to collect the values and store them in twenty-five variables where one variable corresponds to one cell. A z variable is also created to hold the z value for that part.

TWOM operates on the values in the table and the program then displays a spreadsheet with the values in the cells where the TWOM function has wrapped a span around each cell item and the client-side program has attached a DOM input event to each cell. In one example, assume that the user had entered the value “5” into cell (x=1, y=3), and the user entered the value “7” into the cell (x=2, y=1). The user then opens a math operations part on the same page as the spreadsheet part. For a spreadsheet list of mathematical operations and formulae, the math operations part while in edit mode displays as a list of math operations. In one embodiment this is a drop down list, and in another embodiment it is a list of buttons where each button has an input event that opens a list of math operations from a library and the libraries of math operations in the math operations part is comprised of the list of arithmetic, algebra, geometry, trigonometry, calculus, linear algebra, probability math, scientific experiment math, financial math, and process analytics math. The list always begins with a “basic” library that serves a library of basic arithmetic and algebra.

In this example, assume that the user clicks the basic library button, which opens a list of buttons where each button represents an arithmetic or algebraic operation on the list comprising the buttons labelled “Name,” “Variable,” “(_)”, “+ (Plus)”, “− (Minus)” “* (Times)”, “/ (Divided By)”, “= (Equals)”, “Frac(A/B)”, “Expon(ÂB)”, “Percent,” and “Average.” In this example, the user clicks the “select” command, then cell (x=1, y=3) which you will recall holds the value 5, he then clicks “+”, he then clicks the select command, then clicks cell (x=2, y=1) which holds the value 7 to select that cell, he then clicks “=(Equals)” button, and he then clicks cell (x=3, y=4). The result of this series of click events is that the cell (x=3, y=4) in the spreadsheet now holds the value “12”, and that cell is selected with a CSS border and displays a cell detail line at the top of the spreadsheet part where said cell detail line contains four boxes in a row and the first box says “5 (x=1, y=3)”, the second box says “+”, the third box says “7 (x=2, y=1)” and the fourth box says “=(Equals) 12 (x=3, y=4)”.

In other words, when the user clicks the select command and then clicks a cell this selects the cell and this adds that cell's data to the chain of math operations in the formula, and when he clicks a math operation from the math operations list part he adds that math operations applied by the previous value in the chain to the next value in the chain, and clicking the “equals” command followed by a cell stores that chain in that cell with the result of the chain outputted in that result cell. Note that click events on a laptop are functionally equivalent to touch events on a smartphone for identical software logic.

However, while chains are stored in a spreadsheet, equations which consist only of variables and math operations that are built from combining the prebuilt math operations in the program and/or already existing stored formulas made by the user are given a name by the user and saved and are then stored in the math operations list part data storage, such that the name appears on the list and clicking the name adds that equation to the chain. In read mode a math part then displays a list of such user-defined math formulas saved in that part.

The user can click the “New Math Operation” command in the math operations part which takes a name value and then opens a math operations detail which displays as a row of boxes and the user may add a math operation to each box by clicking the box and then clicking the operation in the math operations list to build a more complex math operation which is given the inputted name and applied by selecting that name on the math operations list and then selecting cells to apply it to. In this way, custom math operations can be added to the math operations that ship with the software. Plug-ins can also add new math operations to the available libraries.

Clicking the “Variable” command in a math operations list and then clicking a cell or a box in an equation builder detail takes a name value and then both creates a variable used for the internal math processing such that the variable is processed in the math, then outputs that variable name in other cells or equations when the result exists in relation to that variable, and causes the cell or equation to display an input box permitting a value to be entered into the variable which will then process upon a “process” command to calculate the math with that value in the variable.

For an example of using variables and building and using custom named math operations, assume that the user clicks a first cell, clicks “Variable,”, enters the name “A”, clicks the “Expon” operation, enters “two” as the power value, clicks “+,” clicks a second cell, clicks “Variable,” enters the name “B,” clicks “Expon” and enters the value “two,” clicks equals, clicks a third cell, clicks “Variable,” enters the value “C,” and clicks “Expon” and then enters “two,” and then while the third cell is selected clicks a “save to math operations list” command, and names the math operation “Â2+B̂2=Ĉ2”. Then if the user later opens a spreadsheet part and opens a math operations list part and clicks the “Â2+B̂2=Ĉ2” math operation and then clicks a first cell and then clicks a second cell and then clicks a third cell it will chain the cells with the first cell as A and the second cell as B and the third cell as C, and if the A cell and B cell already have values then it will calculate the answer and output it in the C cell. However, in one embodiment such a math operation already exists in the geometry math library of the prebuilt math operations, and this is an example only.

When a user enters text into a cell to create a cell with a text value and then clicks that cell and then clicks “Name” and then clicks a second cell (or, in another embodiment, clicks the data cell, then Name, then the text cell) then this act assigns the name in the text cell to be the name of the data content of the second cell. Up front, note an important difference between these embodiments and the prior art: the name is the name of the item of data itself, not the name of the cell. If the second cell contains a number or a variable or the result of an equation or a chain of mathematical operations then this content is so named. A name displays in a cell detail as “Name: Value,” for example, “Profits: $32,000”. Names can be chained to other names so that a cell can have “Name1: Name2: Value,” and a name chain can have any number of names in the chain. For example, a user names a group of cells containing a revenue cell, a cost cell, and a net profit cell, with a name that describes its content, e.g. the net profit cell is named “Net Profit,” and the user then names that group of cells with the name “Year 2014,” in which case the cell detail of the net profit cell would be, in this example, “Year 2014: Net Profit: $75,394.90”.

A user may select a group of cells and then click an operation and then click “Equals” and then click a cell and this causes a process such that the operation is applied to the values in the selected group and the result is outputted in the result cell. To select a group the user selects (i.e. clicks or touches) in one embodiment “Select” or in another embodiment “Select Group” and then selects a first cell and then selects a second cell and this selects the first cell, the second cell, and all cells in between, and the user can continue to select cells to add cell groups to the grouping until he selects an operation button which ends the grouping.

In an embodiment, if two cells in one row or one column are selected then those cells and all the cells between them in that row or column are added to the group. If the second clicked cell in the group is on a different row and column then the cells selected are a square with the first cell at one corner and the second cell at an opposite corner and all cells within that square are added to the group. Cells from multiple parts with different z values can be added to one group. In an embodiment the cell detail for a chain which refers to the group does not list all cell coordinates for all cells in the group but clicking the group in the cell detail will open a list of all cell coordinates in that group. In another embodiment, a user may click “Select Multiple Cells” and then click each cell individually in a series to select all those cells as one group.

For example, if a user clicks “Average” and then selects a group of three cells and then clicks “Equals” and then clicks a cell to be assigned as the result cell then the values of those three cells will be summed and divided by three and the result will be outputted in the result cell. However, a math operation that takes a specific number of values or only one value will not process on a group with a different number of cells and will return an error message to the user. For example, to use the “Percent” operation you click Select, click a value in a cell, click “Percent”, click select, click a second value, and then click “Equals,” and then click a cell, and the program then multiplies the first cell's value by one hundred and divides it by the second cell's value and outputs the result in the third cell. Thus, “Percent” takes one value before it and one value after it, and will return a “wrong number of data values: this takes _one_{—} value before and _one_{—} value after” error if a different number of values is inputted into it on either the before side or the after side. Any math operation may require a specific number of values before and after it or in total in this way and will output an error message with the correct number of values for the user to try again.

The application of TWOM to the spreadsheet part and math operations part is that the user creates the spreadsheet part, this opens the table of cells each containing form input fields, the user enters values, the user clicks a process command, the program stores the values in variables corresponding to cell locations, the program creates an output HTML table with five rows of five table entries (i.e. five columns), a named span exists for each of the 25 cells in the table, and the names of the spans are used to create a DOM object for each cell in the table, and DOM input events are set up for each span to select each cell. In other words, a TWOM object is created from each cell, the program displays an HTML table of output where each cell has a named span that is used by the DOM to have a click event or a click event and a touch event, and the input events are fed into the program to select cells.

In one embodiment, selecting a cell and then selecting “Edit” opens a form input field in that cell with the old value loaded in for the user to change the value and click “save” which then replaces the old value in the cell with the new value for the cell and if the cell is a source cell this causes all dependent cells dependent upon the source cell to be recalculated. In one embodiment the user clicks or touches an empty cell and clicks or touches “Edit” to input a new value into a previously empty cell. In one embodiment, the buttons representing math operations and logic operations are also given TWOM objects with named spans tied to DOM objects with input events so that the user can interact with the math operations list part and logic operations list part by clicking or touching items on the list.

In one embodiment a spreadsheet part will create twenty-five (or whatever the number of cells per part) data items stored in a numerically indexed array where each data item is one value from one cell in the twenty-five cell five row five column table. In one embodiment there will be twenty-six items in the array, consisting of the twenty-five cell data entries plus one z value. In another embodiment, there are twenty five or twenty six variables, but not necessarily in one array. In one embodiment, a final save command causes the client-side program to send the data to the server-side script to be processed and then saved in the document database. In one embodiment the record has one content field, in one embodiment there are twenty-five fields in one record, and in one embodiment there are at least twenty-six fields in one record, where each field takes one value from the data.

In one embodiment, if the user clicks a cell or group of cells and then clicks “Style” then a drop-down menu appears enabling the user to apply CSS classes to the cells that can apply one of a premade list of styles, including text color, background color, font family, and bold face. However, in one embodiment the list of styles that can be applied to spreadsheet cells is much more narrow than the full list of styles for word processor text parts and does not include changing font size or spacing. And in one embodiment there are no style options for spreadsheet data and cell output cannot have CSS styles applied to it.

In one embodiment, the math operations fall under libraries of the following categories. This list is not intended to be exclusive or exhaustive, and a person having ordinary skill in the art can find any commonly known body of mathematical or financial knowledge and convert it into prebuilt math equations that a computer can process, which is the only requirement for a person having ordinary skill in the art to easily add a different library of prebuilt operations to the math operations part.

One library is arithmetic, which contains addition, subtraction, multiplication, and division, with support for fractions, exponents, and roots. One library is algebra, which would solve equations containing variables, constants, and coefficients, such as, for example, AX̂P+BX+C, or (X+A)*(Y+B). One library is geometry, which contains sets of equations for lines, circles, curves, rectangles, triangles, pyramids, cones, and cylinders, and other shapes, where these equations describe well-known relationships between angles and line lengths, such that the user can select a shape (a Name value) and input some numbers for angles in degrees or radians and/or sides and the program will calculate other angles and/or sides or a fully defined shape with all angles and sides defined. The geometry library also has operations for area and volume and support for pi. One library is trigonometry, which has named operations for sine, cosine, tangent, cosecant, secant, cotangent, arcsine, arccosine, and arctangent, all of which are used to evaluate relationships between the sides and angles of right triangles, with various other applications of trigonometric operations.

One library is calculus, which finds the derivatives and integrals of functions to measure rates of change by finding the tangent lines of curves or the area under curves. One library is linear algebra, which uses a set of math operations and formulae which by now are standard and well-known in academic math, in order to translate linear mapping between coordinate systems using vector spaces and vectors and scalars.

One library is probability math. This library includes an operation to calculate the standard deviation for a set of values. The standard deviation is used show whether or not a data set is statistically meaningful or random and therefore not meaningful. In one embodiment there are other probability math operations also in this library.

One library is scientific experimentation math. In its most basic form, this takes an independent variable (IV), and a dependent variable (DV), both of which are Name values that can be assigned to cells in a spreadsheet, and asserts a cause-and-effect relationship between them. The experiment can also perform manipulations (M) of the independent variable, and name each different manipulation. The experiment can name potential confounds (PC), which are variables other than the independent variable that may affect the dependent variable. The experiment asserts a hypothesis and asserts that if the hypothesis is true then a given relationship R will exist between the independent variable and dependent variable or that change C in the independent variable will result in effect E on the dependent variable, and each manipulation M is a different C expecting a different distinct E. An experiment is meaningful if the expected correlation between changes in the IV and DV are found and the change is shown to be statistically significant, such as, for example, to have a standard deviation greater than two to be possibly not random and to have a standard deviation greater than six to be probably not random. The user can then set up the scientific experiment math in a spreadsheet by assigning variable names and types to cells and applying scientific experiment math operations to the cells and then plugging the data into the cells and clicking “process” to see the results.

In one embodiment a spreadsheet set of templates also exist that can be used for scientific experiments, and each template applies the scientific experiment math operations to cells in a prebuilt pattern. In one embodiment the scientific experiment operations library and templates comes with a set of Name buttons including “Certainty(%)”, which is applied to a logic part true or false value applied to a text cell, “If the Hypothesis is True We Expect This (Expect)”, which is applied to a text cell, “Verified,” which is a logical condition that can be evaluated to true or false based on what the math shows once empirical data is entered in the spreadsheet, and “Refuted,” which is also condition that can also be set up to evaluate to true or false based on the math applied to real data, e.g. “(The Car Tires are Defective)=(Refuted) if ((Car Tire Data on Success in Road Conditions) is greater than (Failures that indicate Defective Tires) and (Car Tire Data is statistically significant))”. Note that this example presumes operations of both a math operations part and a logic operations part.

In one embodiment, the program has a prebuilt set of financial math features comprised of math operation libraries and associated templates which apply the financial math operations to named cells in specific patterns. The financial math libraries and associated templates include balance sheets, cash flow statements, profit and loss statements, calculating discounted cash flow, calculating net present value, calculating yields, calculating rate of return, calculating compounded interest, applying depreciation and amortization over time periods, and calculating and comparing the price-earnings ratios of stocks and other investments. In one embodiment the program also features a library of math operations and associated templates for tax analysis, including basis, income, loss carry-forward, and tax bracket analysis.

In one embodiment, the program has a prebuilt set of process analytics features, which is loosely modeled on Six Sigma quality control metrics, which is a system for identifying opportunities to succeed, measuring the number of successes from among the opportunities and the number of failures from the opportunities, identifying the process used by the business, measured the rate of success for a process, and comparing and designing processes in order to find a goal process that limits failures to 3.4 failures per one million opportunities to succeed.

This process analytics library includes buttons to apply Names to cells for Success Rate Measurement, Profitability Measurement, Success of Process Compared to Replacement Process Measurement, Profitability of Process Compared to Replacement Process Measurement, Contribution of Success to Profitability Measurement, Profit Per Success, Cost Per Failure, Cost of Obtaining Opportunity to Succeed, and a set of Names including Opportunity, Success Rate, Successes, Failures, Total Profit, and Goal: Total Profit. The library includes operations that combines success rates with the scientific experiments package so that the user can run an experiment to test a hypothesis regarding the success rate of a process or how a process as independent value affects a dependent variable like sales or profit margin. The library includes operations that combine success rates with probability math, to identify meaningful statistics as compared to random coincidence in the process analytics. And the library includes a package of math operations that a person having ordinary skill in the art could learn by reading entry-level books describing Six Sigma mathematics.

For a spreadsheet logic operations part, the program operates substantially the same as with the math operations part except that instead of libraries of math operations the part lists logic operations that can be clicked or touched to be applied to cells in the spreadsheet. Like the math operations part, the logic operations part displays a list of libraries where clicking a library opens a list of operations in that library such that a menu-like path can be used by the user to find a specific operation.

Like the math list, the first item in the logic operations part is a “basic logic” library that contains a list of commands comprised of the following: Element (which assigns a Boolean variable to a cell. A Boolean variable is a variable that holds one of two values comprised of either True or False), Name (which enables the user to assign a name to an element), Define Statement (which enables the user to assign a text string to an element which describes the semantic meaning of the element for the user), True, False, Is (True/False), Equals (==), Not (!=), And (&&), Or (∥), “if A then B and if not A then C” (which is coded using if-else statements, e.g. if (A) {B;} else {C;}), and “if A is B then C and if A is not B then D” (which is coded using if-else statements, e.g. if (A==B) {C;} else {D;}). In one embodiment, the basic logic library also includes “XOR”, which is a computer logic term such that if (A XOR B) then “(A or B) and not (A and B)”. In other words XOR means one or the other but not both together.

The logic operations libraries include the following list, which is not intended to be exhaustive or exclusive, and a person having ordinary skill in the art could add other libraries. In one embodiment, one logic library is Directional Logic, which assigns six interconnected Boolean variables to each element, these values being Forward, Backward, Left, Right, Up, and Down. In one embodiment, True can flow between two elements in one direction while False flows in the other direction. Each directional relationship can be assigned to describe the relationship between two elements, and one directional relationship can be applied to two cells, such that one cell is Forward to another cell. Thus, directional relationships can be defined between elements to represent to the user the lines of relations that exist between the elements that the user seeks to analyze.

In one embodiment, the Directional Logic elements have further properties of one-way or two-way, which determines whether True and False can flow between both or only from one to the other, and From/To, which indicates that a True or False value is going From one element To another element. In one embodiment of the presentation parts described later, the Directional Logic relationships are converted into lines that display between the names or symbols of the elements in the graph.

In one embodiment, one logic library is cause-and-effect logic. This enables the user to assign Names to Elements including Cause, Effect, Single Possible Cause, One of Multiple Possible Causes, Single Possible Effect, One of Multiple Possible Effects, Necessary Cause, Potential Cause, Mutually Exclusive Effects, and Combined Cause. When these Names are assigned they plug into a set of prebuilt logic operations in the library. For example, When X and Y are Combined Causes of Z, and X and Y are both True, then Z is True. If Effect of Necessary Cause is False then Necessary Cause is False. If Necessary Cause is True then Effect is True. If X and Y are the two Multiple Possible Causes and Effect is True then X or Y are True. In one embodiment, if a Cause has two Mutually Exclusive Effects then if Cause then Effect One XOR Effect Two.

In one embodiment, one logic library is legal case analysis logic. An example of legal case analysis logic is “if (A and B and C) then D,” where D is the legal test or standard or burden to be met and A, B, and C are the factual elements of the case that must be true for the legal test to be satisfied. In one embodiment, A, B, and C are facts which are either True or False, and if all are True then the legal doctrine of D is satisfied, in which case the party asserting D wins and the party opposed to D loses at trial. This reflects the nature of the law and trials, where typically a party asserts a doctrine that they seek to win on, and the case is decided based on whether a set of facts satisfy the test for the doctrine in which case that party wins or whether the facts fail the test in which case the party asserting the doctrine loses. The legal logic can also create a doctrine that includes another doctrine or is made by combining two doctrines. For example, Doctrine P has elements A and B and C, and Doctrine Q has elements X and Y. A user can select Q and then add P to Q and rename it as Z, so that Z is P plus Q, and then undertake an analysis of Z with distinct P and Q that shows the full legal significance of A, B, C, X, and Y, in terms of Z, P and Q. So, if A, B and C are true and X and Y are false, the P test is met, the Q test is failed, and the Z test is failed but the P test within Z was met.

The legal logic library asks the user to follow a series of steps comprised of the following: First, load in the case elements to be met by assigning names to cells and specifying the logical relationships between said cells. Second, load in the facts, comprised of entering True or False into each cell representing a fact, based on data or facts revealed by investigation or interviewing witnesses or examining evidence or during trial. Third, enter a “process” command for the program to evaluate the True and False values of the facts applied to the logical relationships between the elements. Fourth, the program displays the results of its legal analysis by assigning True to doctrines and tests which are met and False to tests and doctrines which failed to be met by the facts, where said assignment outputs these values in the result cells with Names for the doctrines and tests. In other words, the program analyzes the data using the logical relationship structure defined by the user in order to assist the user in reaching conclusions about the legal significance of the facts.

In one embodiment, there is a set of templates that are companion parts to the legal logic library. In one embodiment two mathematical values are associated with each case, one of which is the potential maximum monetary damages upon success at trial, the other is an estimate of the actual damages expected if the plaintiff wins at trial. In one embodiment, the legal logic operations also include a financial logic extension that accepts values for the lawyer's estimate of the probability of a win or loss at trial combined with the damages amount of a win or loss at trial to quantify various ranges of the cost of going to trial under different scenarios. In one embodiment, the program includes, or can have added to it at the user's request, a prebuilt library containing templates with the major legal doctrines in American law and lists of Name values for their elements, so that a lawyer can use or modify the template for the law at issue in his case by plugging fact data into the Named element cells or adding his customized interpretation to the cell Names and their logical relationships.

In one embodiment, one logic library is financial analysis logic. This library includes the set of logical comparison operators that convert relationships between numbers into True/False values. These comparison operators are native to most programming languages, including the client-side web browser language JavaScript and the server-side language PHP. These operations include == (Equals), < (Less Than), > (Greater Than), => (Greater Than or Equal to), and =< (Less Than or Equal to). In one embodiment, these can be combined with Not (whose symbol is “!”).

As mentioned, when numbers are plugged into an equation with a comparison operator it evaluates to a True or False Boolean value that enables math to then be translated into Booleans to be processed by logic. The financial logic can be combined with math operations from the math operation part in a template part for a financial statement. It is possible to open a spreadsheet, create a chain of cells using operations from both the logic operations part and the math operations part, and thereby create a spreadsheet which integrates math analysis and logic analysis. Where the spreadsheet includes variables, it can then be saved as a template, and data can be entered and processed to process data using a complex math and logic analytic structure created by first defining logical relationships between cells, then creating mathematical chains for cells, and then inputting mathematical data and True/False values, and then clicking a “process” command, which then executes each logic operation and math operation in the order they exist in the chains on the inputted cell data, the result of which is math results and True/False results that can help the user to analyze data.

For an example of a chain that combines math operations and logic operations, a user could create a chain whose cell detail would be “if (Sam Jones's Sales are greater than or equal to one hundred units in Month January) and ((Company profits in January are greater than $100,000) or (Not: Company Product: Widget losses in January exceed Company Product: Widget revenues in January)) then “Sam Jones gets a Bonus” and Sam Jones: Bonus Equals=(Sam Jones's Sales*(Company Product: Widget revenues in January)/(# of Employees in Widget Sales Department)). The output number in this result cell is, for example, “Sam Jones gets a Bonus: True; Sam Jones: Bonus: $3500”, where as a result of crunching the data the program evaluates that is true that Sam Jones gets a bonus and where $3500 is the numeric value of Bonus.

Generally, a computer programming language will have native support for a set of arithmetic operations, logic operations, and comparison operations. The client-side programming language JavaScript has this, and the server-side programming language PHP also has this, as do other embodiments in other languages. In one embodiment, a chain of math and/or logic operations is conducted by inputting data from the spreadsheet parts into variables and formatting said variables using math and logic operators in the programming language and then letting the client-side program or server-side script evaluate the variables by performing the math and/or logic operations on the values, which produces a result that is assigned to the result cell. For example, if one cell contains the value “five,” and another cell contains the value “seven,” and a result cell contains the chain comprised of the first cell plus the second cell, then the program will format the chain into a variable containing the first cell's value, the symbol in the programming language that corresponds to the math or logic operation (e.g. “+”), and a variable containing the second value, and will evaluate the expression and store the result in a third variable which has a value that is then assigned to the variable that holds the content of the result cell in the spreadsheet twenty-five cell table. For example, the program will format the spreadsheet chain into a statement (Cell1+Cell2=varResult) and then evaluate it and then output the value of varResult to the named span DOM object for the result cell.

In one embodiment, each math operation has its own function which takes the input cells as variables and returns the result, for example the function mathAdd(Cell1, Cell2) {varResult=Cell1+Cell2; return varResult;}. In this embodiment math chains are performed by a series of the functions. In one embodiment all math operations are reduced to the basic math operations such as “+,” “−”, “*”, and “/”, except for complex math operations which are reduced to native support for said complex math operations in the computer programming language or an extension library.

In one embodiment, all logic operations are reduced to Boolean variables (which can only hold the value “True” or the value “False) operated upon by basic logical operators including “and,” “or,” and “not,” “is equal to,” and “is not equal to.” In one embodiment “if, then” statements are processed using a function that uses the programming language's native “if else” syntax to simulate a native logical “if then” statement. In this embodiment, the logic chain stored in a cell is, for example, “if (A==True) then (B=False)” which means “if A is true then B is false”. This “if A then not B” statement is processed in the program by, for example, first having written a function ifAThenB(A, TruthValueOne, TruthValueTwo) {if (A==TruthValueOne) {B=TruthValueTwo; return B}}, and then executing CellTwo=ifAThenB(CellOne, True, False), the semantic logic of which is “if A then not B”.

In one embodiment, for logical operations “and”, “or”, and “not”, the logical chain is reduced to an expression comprised of variables and the programming language's commands for said basic logical operations and then evaluating the expression and then assigning the result to the result cell. For example, the chain “if A and B then C and if not A and B then D” would be processed by creating Boolean variables A and B and then writing “if (A && B) {return C;} else {return D;}”.

In another embodiment, each logical operator has its own function, and the logic is processed by calling a series of the functions. For example, the chain “if A and B are true then C is true and if A or B are not true then C is false” would be processed by first writing a function ifAandBThenCifNotthenFalse (A, B, TruthValueA, TruthValueB) {if ((A==TruthValueA) && (B==TruthValueB)) {resultBooleanC=True; return resultBooleanC) else {resultBooleanC=False; return resultBooleanC;}. The program would then evaluate the equation and output it in the result cell by code such as, for example, resultCell=ifAandBThenCifNotthenFalse (A, B, True, True), and then assigning the value of resultCell to the output cell in the spreadsheet that the chain result is assigned to, i.e. to the cell that is named C.

In one embodiment, the client-side program formats the math and logic chain of operations into a standard syntax and sends it to the server-side script and the server-side script then processes it by performing each math or logic operation on each value or variable in order to arrive at a result which the server saves or sends back to the client web browser. In this embodiment, all math and logic processing is done on the web server and the results are sent back to the client web browser. In another embodiment, the client-side program performs such math and logic processing at it is capable of and only sends data to the server-side script for math or logic processing if the web browser's native math and logic capability does not support the operation. In an embodiment, the web page can directly output results without needing to communicate with the web server, and in another embodiment the web browser will send its results to the web server for data storage and output them to the user simultaneously. In some cases, such as calculating standard deviations, a server-side script coded in the PHP programming language can use PHP's libraries which extend its set of math operations, which libraries include operations to calculate a standard deviation, so at least some or all of the math processing may need to always be done on the server and cannot be done client-side.

In one embodiment, the math operations part and logic operations part behave differently whether the user is in edit mode or read mode. In edit mode, the part displays a list of top-level libraries where clicking a top-level library then opens a menu of sets of operations or a list of operations. An operation can be found by navigating the menu tree structure and an operation can be selected by clicking or touching it. In contrast, in read mode the math part or logic part outputs a list of operations, which in some embodiments is either a list of user-created named operations if the user has created operations, or a basic list of math or logic operations if the user has not filled the part with custom defined operations. In one embodiment the read-mode list displays only the names of the operations. In one embodiment the read-mode list outputs the names of the operations and the text describing the content of the operations.

An example of a user defined math operation is “(Variablê2)+7”, which we can assume the user has assigned a Name value of “Square Seven.” Operations saved in a math part or a logic part are all compounds and combinations of operations that are prebuilt into the program.

The math part and logic part saved user-defined operations differ from a user-defined chain in a template because in the math list or logic list what is saved is a numbered list where each list item is a math or logic equation, and there is no cell or cells associated with a part of the equation (until the user assigns the equation to the content of cells), whereas in the template the cells give a spatial orientation to saved chains. For example, Square Seven as a math operation is saved as the content detailed above, but if a spreadsheet template part is opened and “Square Seven” is applied to a cell (e.g. x=2,y=5) as input and then the result is applied to a different cell (e.g. x=3,y=5) then the values can be plugged right in. For example, with a value of “3” entered into the input cell, the result cell will display “16.” Formulae are abstract until their elements are assigned to cells, whereas templates are concrete visual implementations that can be manipulated by the user and which process data entered into them.

In one embodiment a user-defined custom operation is stored using tokens that represent the prebuilt operations that form the custom operation. In one embodiment, these tokens are also stored in the table of data cell values to represent the operations in the chains in the cells. In one embodiment, references to one cell in another cell are stored as, for a non-limiting example, (x=5, y=3, z=22), where the x, y, and z values signify the specific cell in the document that is the object of the referral. In one embodiment, user-defined custom equations in a math part or logic part are referenced using a set of numbers where the first number identifies the part and the second number identifies the equation on the list in that part. For example, “17-23” would identify the math part that has a part ID of 17 and then specify the 23rd equation in the list of saved equations in that part.

In one embodiment, the tokens for operations are symbols such as “+” and “̂”. In one embodiment the tokens are words that are taken from a prebuilt data table that matches word to operation, for example “OpAdd” and “OpExpon.” In one embodiment the tokens are numbers that are taken from a prebuilt data table that matches number to operation, for example “1” and “5.” In one embodiment the token for a user-defined custom operation is the text name of that operation, for example “Square Seven.” In another embodiment user-defined custom operations are assigned a number ID.

In one embodiment one part may contain an infinite number of user-created custom defined operations. In one embodiment there is a limit of the number of custom user-defined operations in one math part or logic part. In an embodiment this limit is twenty-five. If the limit is reached then a new part must be opened to store further operations.

In one embodiment, each spreadsheet contains a “to-be-updated” variable that holds an array of the z values of every other spreadsheet with a dependency relationship to that spreadsheet. When a cell that holds a dependency relationship, in other words a source cell, is modified by the user or changes as the result of the source cell being dependent on another source cell then the server-side script opens all spreadsheets with z values matching the z values in the “to-be-updated” variable, and then recalculates all dependent cells in those spreadsheets using the new value that the user inputted or which changed as a result of a different value in the prior source cell. In one embodiment this updating is done automatically without the user's knowledge, and in another embodiment the program notifies the user as to which other spreadsheet parts were updated.

For a spreadsheet template, a template is a spreadsheet where some or all of the Names, math operations, logic operations, and references of result cells to source cells, have already been filled in and saved. In one embodiment, a template contains variables, and the user can enter data into the variables and then click a “process” command which then processes the data using the math operations, logic operations, and cell relationships, that were predefined in the template. In one embodiment a set of templates is included in the program by default. In one embodiment the user can enter variables into a spreadsheet and then save it as a template to reuse it. In one embodiment filling all variables with data and processing the template converts it into a spreadsheet table of data part.

The following, as elsewhere in this specification, speaks of clicks but in one embodiment each mention of a click could also include both a click and a touch event. Also note that where the disclosure speaks of an array, a different yet similar embodiment could replace an array with a set of variables. For example, one embodiment would have an array with ten items, and a different embodiment would instead have ten variables, and these would function the same in the software logic. Nothing in this specification is intended to be unduly limiting, as explained.

In an embodiment, the coding of the cell in the computer program is a statement where each source cell is referred to by its x y z coordinate, and each math operation is referred to by its token, and each name is an item in the named cell that is comprised of Name: following by the coordinate of the cell containing the name, and each variable is referred to by its cell coordinate or its name Variable or by the actual name of that variable in the computer code. This coding is, in an embodiment, what would actually be stored in the array variable for the cell in the template twenty-five cell table that holds this chain.

In one embodiment, a user can acquire and upload and install a set of new templates to add new templates to the program in addition to the prebuilt sets of templates that come with the initial installation. For example, a user may require a template for a specific complicated financial computation like a mergers and acquisitions analysis, and may acquire and install a template for it. In this embodiment, all math and logic operations in the new template are compounds or combinations of math and logic operations that are native to the program, so the program will have the native ability to perform the math and logic. Similarly, a plug-in or file can be uploaded to add new math operations or logic operations libraries.

In one embodiment, it is possible for a user to upload a file containing data to the server hosting the program and to have the program then execute the process command to process said uploaded data using the templates and spreadsheets in a document. In one embodiment, the file is composed of at least one or more arrays containing name: value pairs where the name is the Name of the cell in the template or spreadsheet and the value is the data value to be plugged into the Named cell for processing. In one embodiment, the file is a JSON file containing at least one array of said name: value pairs. In one embodiment, the program logic runs much like the find plus replace feature, by searching the content fields of each part for values that match the name values in the uploaded file and then replacing the values of the cells assigned those Names with the value in the file, and then reprocessing each spreadsheet that was updated with the new values where dependent cells are based on changed source cells.

In one embodiment, a user who uses the program hosted on a cloud or on an internal server may set up an external data feed comprised of said files containing name: value pairs being sent to the server automatically or manually by a third party data provider on a regular basis or continuously, and the uploaded data being entered into the Named cells in spreadsheets and templates in at least one or more documents stored on the server, with the results of the processing of the inputted data from the external data feed saved to the output cells of said spreadsheets. For one example which is not intended to limit the invention to this specific scenario, an external data feed could be the values of stock prices paired with the Name of the stock symbol that gets plugged into a template that calculates Price-Earnings Ratios for each stock and saves the results in a spreadsheet, which the user can then view when he is viewing the document containing said spreadsheet to see up to the minute real time stock analysis.

In one embodiment, a user has the option to deploy software to parse text data to break it down into statements or names associated with True/False values, for example reducing the text “The dog named Fido is at the beach” to “Dog: Fido: Beach: True”, and this preprocessed data can be put into a file to be uploaded to the server for processing as an external data feed as described. Said third-party software provider can be given a list of cell Names used by the user in order to create software that can translate natural human language into Name: value pairs using that set of names.

In one embodiment the user also has the option to deploy third-party software to perform external math processing on numerical data to then create a file of Name: number value pairs, which can be uploaded to the server for processing as an external data feed as described. For example, if a user has a data set with one million numbers representing one million different customers, he can use third-party software to aggregate sales data into customer demographics, and then upload the file to be processed by a template containing math and logic relationships among different customer demographic groups. In such an example an array could contain the Name; value pairs: “Aged Over 65: $392; Aged Under 30: $229,” where those two numbers would be plugged into the cells with those Names and then processed, for example by chain “If Sales: Aged Under 30<$500 then increase advertising spend: Next Quarter by $10,000”.

For presentation video parts, audio files parts, and images parts, when the program is first installed the user or owner during setup and installation selects which video, audio, and image file formats to allow in a document. Supported video and audio codecs vary by browser; for example, Chrome supports the open source codec WebM and MP4 whereas Internet Explorer and Safari support the proprietary patented codec MP4. The user or owner can instead select the browser that users will use from a list and have the installation program automatically configure the file types based on the used browser type. All program logic descriptions below assume that the installation steps have already been completed.

In one embodiment the program outputs video parts using the HTML5<video> tag, and it outputs audio parts using the HTML5<audio> tag, and it outputs images using the <img> tag for image parts, and outputs images using the <canvas> tag for images in a canvas part. HTML5 video, audio, and image tags take a source attribute that directs the browser to display or play a particular file from the server. For example, <audio src=“playThisSong.mp3”> will display an audio player on the web page that will let the user play the file playThisSong.mp3 (assuming that the file is stored on the same server and directory as the directory path specified in the tag).

For a presentation video, the user first selects to create a video part. The program then displays a file upload form using HTML code such as, for example, <form><input type=“file”></form>. The user then selects a video file of a supported format from the user's device or computer. The file is then sent to the server-side script, which saves it in the server as, for example, FileName.mp4. In one embodiment, it then creates an SQL record for the part where the record contains a PartID, a Sequence Number, and a Part Type ID and a content field. In one embodiment, the content field contains FileName.mp4 plus the folder directory path to the file. Also in an embodiment the software validates the file for being the correct supported video file format.

In one embodiment, the part would be outputted by the program interpolating the value from the content field into a variable in an HTML video tag template. For example, the template could say <video src=“$videoVariable”>. The program would then assign the contents of the content field to the variable $videoVariable (note the currency character is used to indicate variables in PHP). This would result in the HTML code that would be used to output the part, for example, <video src=“FileName.mp4”>, because FileName.mp4 would be placed into the value of $videoVariable. A server-side scripting language such as PHP possesses the ability to interpolate variable values into HTML templates in this way. The result of this output is that the user's web page will contain a player native to the web browser with a control that when selected will play the uploaded video file on the web browser video player.

For a presentation audio file part, the program logic works the same way as for video parts except that instead of video files outputted using <video> tags, this audio part uses audio files outputted using the <audio> tag, and validates the uploaded file to be the correct audio format. The end output is that the web page displaying the part will display an audio player in the web browser with a play command that when selected will play the audio file that the user had uploaded.

For a presentation image, the program logic works substantially the same way as for videos and audio files, except that instead of videos and audio files this part allows the user to upload an image file which is then outputted using the <img> tag. Two minor differences are that the file upload validates for the allowed image file types, and also that in an embodiment the server-side script reads the height and width properties of the image when it first processes it. In one embodiment the height and width values are stored in the SQL record content field and are then interpolated into the height and width attributes of the output <img> tag. In one embodiment, the program only records and displays the image but does not record or make use of the height and width attributes.

For both a presentation CSS3 animation part and a canvas animation part, the program generally deals with the animation of presentation items by allowing the user to input or select a set of goal states, assign an animation sequence number to each goal state, assign an animation to the transition from one goal state to the next goal state, and, in an embodiment, assign a value of a one-time animation or a looping animation. The program then processes the user input and sets up an animation where the first goal state is displayed, the first goal state is transitioned to the second goal state using an animation, the second goal state is displayed as a result of the animation, the second goal state is transitioned to the third goal state using an animation (if there is a third state), and so on until the final goal state is reached, which ends the animation for a one-time animation or returns to the first goal state and repeats if a looping animation. In an embodiment all animations loop and there is no option to select a one-time animation.

For the presentation CSS3 animation parts, otherwise known as style animation parts, and the canvas animation part, which is otherwise known as a dynamic animation part, the program logic for creating the part works as follows.

First, the user selects to create an animation part.

Second, the user selects the initial size of the canvas for a canvas animation. In an embodiment the available sizes to select are sizes square, wide, long, and big.

Third, the user selects an already existing part in the document from types including either a word processor part or an image part or a canvas image or a canvas graph. In one embodiment the user may also select from a set of stock images built into the program, including the image of a big arrow pointing left, and a big arrow pointing right. The user then selects to add this content part as a goal state.

Fourth, the user then assigns an animation sequence number to the content part.

Fifth, the user assigns an animation to the goal state to be the animation that is applied when moving from this goal state to the next goal state. The animations are selected from the list comprising: A. move, which when selected asks the user for a from location and a to location, B. grow, C. shrink, D. move and grow at the same time, E. move and shrink at the same time, F. enter (move and grow from edge of screen towards center of screen), and G. exit (move and shrink from middle of screen to edge of screen).

The user then repeats the third, fourth and fifth steps over and over to add each goal state and animation until all goal states and animations are added.

Sixth, in an embodiment, the user then selects whether the animation will run once or loop, and whether to trigger the animation on a new page load or on clicking the “run animation” command that displays substantially adjacent to an animation part.

Seventh, the user then views a preview of the animation, confirms it, and inputs a final save command.

In one embodiment, the user is assisted in selecting move: to and move: from locations by being displayed a cell table and clicking a cell in the table to represent that location on the screen relative to all other locations on the screen, e.g. top, bottom, left, right, center, upper right corner, upper left corner, lower right corner, and lower left corner. In one embodiment, when a document is outputted in “read” mode the animation part will play when its page loads or its “run” button is clicked, but when the document is viewed in “edit” mode viewing the part displays a list of goal states which the user can click to edit both that goal state and the animation that moves that goal state to the next goal state. In one embodiment one CSS3 animation part or canvas animation part may have up to a limit of goal states, after which the user must create a new part to extend the animation. In one embodiment the goal state limit is twenty five. In another embodiment there is no limit to number of goal states in one animation part.

Although the CSS3 animation part and the canvas animation part are similar in their input, they differ in how the output is structured as computer programming code. The CSS3 animation is outputted using CSS3 animation techniques, while the canvas animation is outputted using a <canvas> tag combined with a canvas creation function running in the client-side program, which in one embodiment is written in JavaScript.

The CSS3 animation uses various CSS3 features, including the transform: translate, rotate, scale, and skew rules, the three-dimensional transform rules, and the transition rule, which animates an element from one CSS rule to another CSS rule over a duration, and the animation rule, which accepts key frames and animates the element from one CSS key frame to the next in an animation, and can loop endlessly. The CSS3 animation part also allows the user to apply a CSS3 border to the animation goal states (for example, a box shadow, image border, or rounded-corners border) or to apply a background image to the part.

It is worth noting that CSS3 animation implementation varies greatly by web browser model. Some browsers have not implemented the feature at all as of 2014, some browsers have limited support for animating position, movement, and changing color, and some browsers vary in which CSS rules may be made the subject of animations. In one embodiment, if a browser does not support CSS3 animations then the program will seek to emulate it by running a client-side program function that is a time interval function that calls a function that changes the CSS rule and calls this CSS rule change function repeatedly rapidly over very small time increments to make it look like a smooth animation of the content over a range of CSS rule values. In another embodiment the software simply does not animate and will look static if the web browser does not support that CSS3 animation rule.

For a presentation image/text in canvas tag part, which is also called the dynamic image part, in an embodiment the program uses the canvas tag, which is an HTML5 tag that is controlled by a client-side program (typically JavaScript) and outputs an image onto the web browser screen. The HTML includes the canvas tag, and the JavaScript then pulls the graphics context API from the canvas tag and uses it to draw visual content to the canvas tag image. The canvas tag can apply styles to its content including stroke, which styles lines and text, and fill, which applies a color or image to lines and text. The canvas tag can draw text and text shadows. It can draw lines, shapes, circles, arcs, and curves. It can pull an image from the web page or the server and display said image. It can also draw a portion of an image, and it can convert images to pixel data and apply red/green/blue filters to the data and then redraw the filtered image.

For the canvas image, the user selects a preexisting word processor part such as a text part or an image part from elsewhere in the document to be the input content parts, and outputs the input content parts into a canvas image. When the user defines a canvas image 18 he may select multiple input parts and layer them, such as, for example, to create text in an image. In one embodiment, he may also select to apply one of a preselected set of fill and stroke options to the input part, resize the input part, apply a red/green/blue filter to an image, crop the image, or position one input content part relative to another content part.

When the canvas image part is outputted to a display web page the program logic works by the server pulling the input parts contents data from the database records of the input parts and sending them to a client-side program along with data from the canvas image part database record, and the input parts content and the canvas data are fed into a canvas creator function that analyzes the inputs content parts data and canvas data and user selections and formats a canvas content (e.g. text and/or an image) for the canvas (e.g. by applying a user-selected fill style to the text) and then outputs said canvas content to the canvas.

In an embodiment the SQL database record content field or fields containing the canvas image part holds references to the input content parts along with identifiers for the selected options for how to output them, and holds a part ID in the part ID field identifying the part as a canvas image. In one embodiment, to output an image the program outputs said image to the web page through an image tag using a non-display attribute for the image and then pulls the image from the web page into the canvas and then processes said image and then displays said image through the canvas, because it is sometimes faster to pull an image into the canvas from the web page than from the server.

For a presentation canvas animation part, an animation in the canvas works by the JavaScript calling a time interval function which redraws the canvas repeatedly over very small intervals with a small change in each draw so that to the user the image appears to be moving, not unlike the frames of a movie film creating the illusion of a moving picture. The canvas 2D graphics context API has native support for functions including translate (which moves content), rotate, and scale (which changes content size). Thus, for example, the following example JavaScript code is such that the draw( ) function translates an image one pixel to the right of its prior location, and the initialization function calls draw repeatedly at each one/tenth of a second interval, comprised of:

function init( ){
setInterval (draw, 100);
function draw( ){
con.clearRect (0, 0, 400, 400);
x += oldx;
y += oldy;
con.drawImage(imageName, x, y, imageWidth, imageHeight);
}

So this code would animate an image to move to the right. However, canvas animation actually uses linear algebra to redraw images, so in reality the code could be far more complex and detailed, however a person having ordinary skill in the art would know how to do this.

So animation in the canvas can move, rotate, grow, shrink, create, destroy, enter, exit, or change in any way that a motionless text, line, shape, or image can be created in a canvas image. The canvas animation part gives the user the ability to build an animation using the same seven-step process as the user uses to build a CSS3 animation part, and the user has the same options for creating and styling goal states and animations that go from one goal state to the next. However, in the canvas animation part the user may also select a canvas image to be a goal state for a canvas animation.

A presentation canvas graph image is a canvas image that outputs a graph of data from a spreadsheet part into a canvas image using software logic that translates the data into a canvas graph. A canvas graph image can be made from any spreadsheet, but the graph items will have names where it is made from a spreadsheet where data cells are named, or from a spreadsheet using math operations with defined names and/or templates which come with names such as the math operations library for geometry (shapes) or for financial math.

The user selects to create a canvas graph image and then selects the input content spreadsheet comprised of a spreadsheet part. In an embodiment, the user is then displayed a list of cell Names or shape identities or financial data Names taken from the input spreadsheet and is given a graphical user interface for assigning sequence numbers to these items. In one embodiment the user clicks a symbol representing the item (such as the cell Name) and then clicks a number from a list of numbers to assign sequence numbers to items. In another embodiment, the user is displayed the table of data itself and simply clicks a data item to select that item and then enters input to assign a sequence to that data item. In an embodiment, the user may select to assign a sequence value of zero to an item, in which case it will not be displayed in the graph at all.

In one embodiment, the user can also select a color for each item. In one embodiment color selection is done using the HTML5 native color selector form input item. In another embodiment, the user is displayed a list of colors and clicks an item and then clicks a color to assign the color to the item. In one embodiment, the user can select a fill or stroke style for each item. In one embodiment, for financial graphs the user can select a bar graph, or a pie chart, or a line chart where each vertical line is a data value and horizontal lines are drawn between the tops of each vertical line.

The user then selects the size of the canvas graph. In an embodiment, sizes are selected from the list comprised of a small square, a wide rectangle, a long rectangle, or a big square. In one embodiment, each size has a predetermined pixel size for the canvas output associated with that size. In one embodiment, the user can select whether he wants the items in a horizontal row or a vertical row and the number of total rows in one graph and whether values should extend up from the bottom (vertical) or right from the left (horizontal). In another embodiment the user may enter an actual number for how many pixels of size he wants the canvas image to occupy. In one embodiment he may enter the area size of pixels, and in another embodiment he may enter a horizontal pixel width value and a vertical pixel length value.

In one embodiment, the canvas creator function to create the canvas graph image calls a translate function that reads the size of the canvas selected by the user, calculates the number of items, divides the size of the canvas in pixels by the number of items plus some predefined amount of spatial padding to arrive at the space size for each item, finds the lower left corner of the canvas, executed a draw function for the item with the first sequence number, moves to the right and/or up by the size of an item, draws the next item, and repeats the process until all items are drawn.

In one embodiment the total number of items is the number of data values plus one, so that when all data values' visual representations are drawn it leaves space for one item left, into which the program then draws the scale key. In one embodiment the scale key is a visual length with its measurements named in data units demonstrated in lines or text. In one embodiment the scale key also illustrates the values that correspond to different colors in the graph. For example, a scale key could show one inch equal to $1,000,000, and could show profit as black and loss as red.

In one embodiment, the draw function finds the scale of the numerical value of the data in terms of the pixel size of the item. For example, if the canvas is 300 pixels tall and the two values are $300 and $150, it will calculate a scale of one pixel equals one dollars, by relating the highest numerical value to the highest pixel size. It would then draw a line that is 300 pixels tall to represent the $300 data item, and draw a line 150 pixels tall next to it to represent the $150 data item. In one embodiment, the draw function finds the scale of what pixel length corresponds to what data value by taking the pixel size of the item space, taking the largest data value, and dividing the largest value by the pixel size of the item space, optionally with some pixels added for padding, and then measuring the size of the pixel space per the largest data value to find a pixel per data value scale, and then measuring each item's pixel size using that scale. In one embodiment, if the result of this measurement is that at least one item smaller than the biggest item would then be too small to see, a different scale may be calculated to make smaller items possible to see. However, this is merely one way to calculate the scale, and other embodiments may use other ways, such as taking user input on scale.

Note that a canvas image resizes in the web browser dynamically when the size of the window changes, but the web browser's software logic usually begins with a firm pixel size for the canvas and then adjusts it based on window resizing So when the user selects an initial size for the canvas, this total size of the canvas will correspond to an actual pixel size, which can be used to calculate the pixel scale for the graph data items, however in actuality the drawings may be a different size, such as, for example, bigger if the browser window was expanded. So, in the preceding example, if the user enlarges the browser window, the $300 item may become 600 pixels large, but the relative scale will still hold true, for example the $150 item would have then become 300 pixels long.

In one embodiment, for geometry items, the draw function draws a line or curve or circle, finds the next point by calculating the angle to swivel by and the length of the next side, and draws a line from the last point to the next point, and repeats the process until the shape is drawn. In one embodiment, for a financial graph item, for a bar graph the draw function selects a color or fill or stroke matching the user's selection for that data and then draws a rectangle with height corresponding to the number value of the data and with width equal to some percentage of the total item space size.

In one embodiment, the program finishes the drawing by drawing a scale key which is a line that is labelled with the numerical value equivalent to its pixel size to permit the viewer to visualize the scale. In one embodiment, the scale key length matches the value that is half the largest value in the data set. In one embodiment the scale key contains a color-name list or a stroke/fill-style name list that outputs a sample block of each color and outputs the Name of the cell associated with it next to it. In one embodiment the scale key lists each Name where the name itself is styled in its matching color or style.

For example, assume that the user creates a spreadsheet part with a cell named Revenue with a value of $90,000, a cell named Cost with a value of $60,000, and a cell named Profit with a value of $30,000, and then creates a canvas graph selecting the options of bar graph in one horizontal row with values defined vertically with Revenue as the first sequence item colored green, Cost as the second item colored red, and Profit as the third item colored black, and selects a small square size. The software program would create a three-hundred pixel by three-hundred pixel square, divide it into fourths to define four one hundred by three hundred pixel item spaces, find the number value per pixel (in this case, dollars per pixel) by dividing the highest value (90,000) by the height of the biggest item space size (300), taking this number as the value per pixel, which is $300 per pixel, and thereby arriving at a scale of $300 per pixel. It then uses this scale to draw the bar graphs by drawing one pixel per $300 of value, so that $90,000 is drawn as 300 pixels, $60,000 is drawn as 200 pixels, etc. The program would then draw each bar as a rectangle in the correct color with the correct pixel height in the user-defined sequence order, with the first item of sequence on the leftmost side, then the next, then the last on the right side.

The program would then include a scale key in the fourth item space that says “Revenue” in green text, “Cost” in red text, and “Profit” in black text, and has a black line that is 150 pixels long labelled “$45,000”. In an embodiment, the scale key is optional. In another embodiment, optionally, instead of the scale key, the text name of each value can be outputted next to its graph item. For example, the 300 pixel line could have a caption above it saying “$90,000”, etc., so that no scale key is necessary.

For a presentation canvas graph animation, the part takes a series of canvas graphs and animates them in a canvas animation similar to the canvas animation part. The user may select a set of different spreadsheets where there are the same set of Names but different values in the Named cells. The program will then take user input on sequence as described for a canvas graph, take user input for animations as described for a canvas animation, and will animate transitions from one graph as one goal state to the next graph as the next goal state with the selected animation transitioning from one end goal to the next, and with each goal state comprising a graph with visual representations of the data values in one of the spreadsheets. In one embodiment, each spreadsheet becomes one canvas graph which forms one end goal state in the canvas graph animation 21. In one embodiment the user has the option to make a canvas graph animation which simply flips from one graph to the next graph without applying an animation transition effect, so that the end user simply sees one graph, then the next, etc., with no animations shifting from one graph to the next graph.

Generally, assuming that the pagination number is four, there are always four electronic document parts in one electronic document page. Pages are positioned on a web page using positional CSS. For a page or for all pages in a document or in a set of pages, the user may select a positional layout template of parts on a page. Each layout template is a positional layout CSS and associated HTML template that can have HTML code plugged into the spaces for parts in order to build the HTML for the output page. The default layout, also called “vertical,” is one column with the parts going from top to bottom in descending sequence priority. In other words, it is one column of four rows. The user may alternatively select a “cross” layout comprised of two rows and two columns, or a “horizontal” layout comprised of four columns in one row.

Spreadsheet parts have a specific set of layout defaults separate from other parts. The user may select a command to create a page comprised of four spreadsheet parts in a cross layout. If the table of data normally has 5 rows and 5 columns, this creates ten rows and ten columns for a total of one hundred cells on one page where said one hundred cells are comprised of four side-by-side tables each of twenty-five cells. In an embodiment the user has access to a button that toggles between the four spreadsheet cross layout and a “three section” layout in which two spreadsheet parts, one math operations part, and one logic operations part, are visible on one page, so that the user may easily click math and logic operations to apply to cells in two spreadsheet parts.

In an embodiment, the user may select to change the sequence number of parts on a page by selecting a menu option. Once selected, the user may click one part, and then click another part, and this reverses the sequence numbers of the two parts. The user may also select a part and then manually input the number of a new sequence number. Generally, the page number of the page of a part is that part's sequence number divided by the pagination number. In one embodiment the pagination number is four. Page numbers go in numerical ascending order from first to last, as do part sequence numbers. The four parts that are assigned to a page will display when that page is displayed.

Parts may be selected, and a document may be outputted to be read, in one of several ways. The first way is as “Long Document,” which outputs the entire document as one very long web page. The second way is in “PageFlip.” This displays one document page as one web page, with a menu along one edge of the page or the top of the page containing buttons for “Previous,” and “Next,” which turns to the previous page or the next page in the document. In one embodiment, this edge menu also contains a “First” button and a “Last” button to jump to the start or end of the document. In one embodiment this edge menu also contains an “Edit” button and a “Read” button to toggle between edit mode, in which selecting a part or part TWOM object opens editing features or content-changing inputs, and read mode, in which the click events for all TWOM objects are turned off so that clicking the page contents has no effect (other than to click a play command for a video or audio part or for opening a new page to load animations on that page or inputting a command to play an animation).

In one embodiment, a user may select a section of parts, a chapter of pages, or a set of parts or pages, to be outputted as one web page. In an embodiment the user may make customized selections of which parts and pages output in a chosen number of output web pages, and may assign a part or page to an output web page manually.

In one embodiment, the user may also toggle between displaying the header/footer/page break parts or not in the document output web pages, whether in PageFlip or in Long Document. In one embodiment, page break parts output as a thin strip of text at the top or bottom of the page section of an output web page. In one embodiment, page break parts are not counted towards the number of parts in a page when a server-side script runs an algorithm to calculate which parts are assigned to a page by processing the page number and pagination number and sequence numbers. In this embodiment the sequence number calculation flows around the page break part sequence numbers. In one embodiment, one page break part applies to a document or a set of pages such that one page break part would display on the pages or page breaks for the entire document or set of pages.

In one embodiment, the user may select other page layout templates, including one column on the left and a column on the right containing three rows, or a row on the top and a row on the bottom which contains three columns, or two cross-style boxes in a big row on the top with two horizontal-style rows beneath it, or two cross-style boxes on the left and two vertical-style columns on the right.

In one embodiment, a user may select a “zoom” for a part which causes one part to display by itself on one output page with no other parts on the output page. In “zoom” mode the zoomed part is removed from the flow of parts sequence numbers used for pagination calculations for other pages. In an embodiment, zoom is a default option on smartphone outputs.

In one embodiment, a user may “rope together” parts so that they always display on the same page and are always on the same page. “Roped together” parts are removed from the flow of parts sequence numbers used for pagination calculations for other pages. In other words, if parts with sequence numbers 2, 3, 4, and 5 are roped, then part 1 will output on page 1, page 2 will output parts 2, 3, 4, and 5, and page 3 will then start from part 6 and output a group of parts equal to the pagination number, and so on.

In one embodiment, canvas image parts, canvas animation parts, canvas graphs, and canvas graph animations have a size selected by the user when the part is created which is selected from the group comprising “small square,” “tall rectangle,” “wide rectangle,” and “big square.” In one embodiment, a canvas part's initial size is always locked to a predetermined number of pixels of length and width based on the user's initial size selection, although the actual size will vary from the initial size based on window resizing or later user alterations to the part. In one embodiment, a big square will output by itself on one page as if it were zoomed. In one embodiment, a small square will force a page layout with a cross-style section for itself to be outputted in, and similarly a wide rectangle will force a horizontal page layout and a tall rectangle will force a vertical page layout to force the correct shape of the section of the page where the part is outputted.

In an embodiment, the user has options for outputting a document comprised of outputting the entire document as one long web page, outputting the document as a series of web pages where each one page outputs one document page, outputting one part per page, or selecting one or more parts and assigning this one part or collection of parts to be outputted as a web page. In an embodiment, a default setting is for one page per web page on laptops and one part per web page to output on smartphones. In a different embodiment, there is no default or the user selects the default from among the options.

In one embodiment, collaboration among multiple users for one document and multiple users discussing the content of a document and referring to document pages and bookmarks via links in messages is done using the AllRef architecture, which is novel to the parts-based structure of a Blackjack document. Under the AllRef system, when a part is loaded into a client-side program to be inputted or edited it is “in progress.” Only one part can be in progress in one web browser at one time. When a “final save” happens the part data is transmitted to the server, which processes the part content and stores it in a database. The document data saved in the database on the data server is the “official” document.

Only one person can be in progress on one part at one time, but multiple users can each be working on a different part of the same document at once, and multiple users can view one part at one time.

When a final save happens a user may keep editing access or the user may surrender editing access to that part, at which point in time a different user may gain editing access to that part, or one user who possesses editing access may give it to another user, which may happen via a link to the part in a message where one user asks another user to edit a part, such that clicking the link by the second user opens the part with editing access in that user's web browser. In one embodiment such a link passes data to the program for it to identify the editing access of the clicking user for that part.

Under AllRef, there is only one official document part at one time, which consists of the record for that part in the database table, so all references to that document part, i.e. all links to that document part, result in the server pulling that document part from the database and outputting a locked un-editable displayed part to the requesting user, unless that is the user who currently holds editing access for that part, in which case an editable version is displayed upon the user clicking the link reference.

A part that is in progress can have its most recent official version be viewed by other non-editing users. In one embodiment it looks like any other part, and in another embodiment there is always a notice displayed that the part is in progress along with the identity of the editing user and the time that the displayed version was most recently finally saved.

In one embodiment, if the part is changed and given a new final save while the old official version is being viewed by another user, a notice is given offering the user the option to replace the old official version with the new official version, and if a replacement happens then access to the old version is lost. In another embodiment no notice is given. Because AllRef means that all links link to one thing which is the official document part, it is possible for all users to be sure that they are seeing the same thing and that they are not seeing two different things when they discuss one part amongst themselves.

In one embodiment, the AllRef architecture is used to integrate the electronic document creator into a third-party system for sending electronic messages, whereby an electronic message can include a hyperlink and said hyperlink either opens a document at a bookmark part or else opens a document by opening an output web page that corresponds to a document page.

In one embodiment, only one user may having editing access for a part at one time, wherein said editing access is privileges to change a part's content. In one embodiment the program maintains a database containing a record where fields include a user ID and the document IDs and part IDs of parts to which that user has editing access. A request to edit a part by a user will then query this access database table and will only serve the part with editing options to the user if the user has editing access to that part. In one embodiment a database table also exists listing which documents or parts a user may view such that a system administrator can grant or deny a user access to view specific parts or specific documents and a request to view a document will query the view database and only serve the document to the user if the view database lists that he has permission to view said document.

In one embodiment, parts can also be grouped into sections, pages can be grouped into chapters, and documents can be grouped into books of documents. In one embodiment, a section may be either contiguous, in which the parts are consecutively sequence-numbered, or dispersed, in which the parts in a section are out of order. Chapters may also be contiguous or dispersed sets of pages. In one embodiment, sections and chapters are included in a table of contents part for the user to organize how he moves around the document. In one embodiment, a section or chapter can be selected to apply a style to all parts or pages within it, such as, for example, applying a CSS style to a set of text parts in a section, or applying a layout style to a set of pages in a chapter. In one embodiment, documents are grouped into books to make it easier to share a set of documents which coworkers, such that a user can send a link to another user wherein the link opens a page which lists all documents in a book and includes links to open to page one of each document in said book.

### CONCLUSION, RAMIFICATIONS, AND SCOPE

Accordingly, the reader will see that documents in the HTML5-based Blackjack document format achieve a web-based word processor, spreadsheet, and presentations document that takes full advantage of the new possibilities of HTML5. Word processor text can be inputted and outputted with ease using any computer or mobile device. Spreadsheets have data math and logic analysis tools that are powerful yet easy to use. Presentations use video and animations that can run on any computer or mobile device.

Although the description above contains many specificities, these should not be construed as limiting the scope of the embodiments but as merely providing illustrations of some of several embodiments. Any computer running a web browser connected to any computer executing a web server could be used for a web-based embodiment, and any logical equivalents of a web browser and web server can be used. For example, software could be configured to run an app on a smartphone or tablet wherein the app would function identically with a web browser for the purpose of inputting and outputting messages by interpreting HTML or HTML-like code, and a cloud server can function identically with a web server. Also note, in this context, that any computer can be configured to act as a web server, so the same web-based document editing software could be run off a dedicated server, or could be run off one or a plurality of local computers running web server software, in a hybrid peer to peer model. How the document parts content is stored, be in in an SQL database, a NOSQL database, or in files a folder in a file directory structure, varies with different embodiments. Also in places where arrays are described herein, collections of variables can be used instead of items in arrays, and for loops can be used instead of repeating lines of code for each variable, such as, for example, when processing each word in a TWOM function.

Thus the scope of the embodiments should be determined by the appended claims and their legal equivalents, rather than by the examples given.

What is claimed is:

1. A system or method of creating an electronic document, comprising:
a. providing a server,
b. providing a data storage device or computer-readable medium connected to said server by a means for connecting computer hardware,
c. providing a computer device comprising a computer input device and a computer output display wherein said computer device is connected to an internet connection by a means for making internet connections,
d. providing a computer program comprised of a server-side script running on said server and a client-side program running on said computer device wherein said computer program creates an electronic document consisting of at least one or more electronic document parts by taking input from said computer device to create said electronic document parts, and wherein said electronic document parts are stored on said data storage device, and
e. further including electronic document part types which define the type of content of said electronic document parts, and wherein said electronic document parts are each of a predetermined size wherein said predetermined size is defined differently for each part type based on the type of content in said part type, and wherein said size is sized for one electronic document part to be able to fill the output display in a mobile device output display and for multiple parts to be able to fill the output display on a laptop output display.

2. The method of claim 1 further including:
a. a sequence identifier identifying an electronic document part's order within its electronic document,
b. electronic document pages that said electronic document is divided into wherein said electronic document pages are determined by a predetermined pagination number such that the first group of said electronic document parts in a group whose size matches said pagination number are assigned to the first electronic document page, the second group of said electronic document parts in a group whose size matches said pagination number are assigned to the second page, and the process of assigning said electronic document parts to said electronic document pages repeats until all parts are assigned to a page so that each page contains a number of parts equal to the pagination number except for the final page which contains the remainder number of parts, and
c. at least one or more output pages that output at least one or more said electronic document parts of said electronic document comprising:
1. an output page containing the entire electronic document,
2. a series of output pages wherein each output page outputs one electronic document page,
3. an output page containing at least one or more parts selected by a user, or
4. a series of output pages wherein each output page outputs one electronic document part.

3. The method of claim 2 wherein said electronic document part type is selected from the group consisting of:
a. a text part,
b. a list part,
c. a table of text part,
d. a fillable form part,
e. a heading part,
f. a link part,
g. a bookmark part,
h. a page break part,
i. a table of contents part,
j. a table of data part,
k. a math operations part,
l. a logic operations part,
m. a template of data part,
n. a video part,
o. an audio part,
p. an image part,
q. a style animation part wherein said style animation part presents at least one or more animation sequences in order wherein each animation sequence comprises an animated transition among goal states that transitions from at least one goal state to at least another goal state using an animation style and further including that each goal state takes content from at least one other part in said document and further including that said animated transition is accomplished by applying style changes to said goal states,
r. a dynamic image part wherein at least one or more other parts in said document are dynamically formatted and dynamically outputted into said dynamic image part by said computer program,
s. a dynamic animation part wherein said dynamic animation part presents at least one or more animation sequences wherein each animation sequence comprises an animated transition among goal states that transitions from at least one goal state to at least another goal state using an animation style and further including that each goal state takes content from at least one other part in said document and further including that said animated transition is accomplished by said goal states being dynamically formatted and dynamically outputted into said dynamic animation part by said computer program,
t. a dynamic graph image part wherein said dynamic graph image part is comprised of a graph created from a table of data part processed dynamically by said program by the steps comprised of taking input to determine the sequence order for output items wherein said input assigns a sequence order in the output to a data item in said table of data, identifying a size for said dynamic graph image, identifying a scale that relates a data item in said table of data to said size, and drawing a graph item to said dynamic graph image part wherein the graph item's size corresponds to a corresponding data item from said table of data by reference to said scale and the graph item is drawn in an order defined by the sequence order for the corresponding data item, and
u. a dynamic graph animation part wherein said dynamic graph animation part presents at least one or more animation sequences wherein each animation sequence comprises an animated transition among goal states that transitions from at least one goal state to at least another goal state using an animation style and further including that each goal state takes content from at least one other part in said document and further including that said animated transition is accomplished by said goal states being dynamically formatted and dynamically outputted into said dynamic graph animation part by said computer program and further including that said goal states each take content from at least one said dynamic graph image part.

4. The method of claim 3 wherein said output pages are output web pages and further including hypertext markup language code in said output web pages and further including:
a. said text part outputted as a text string within a hypertext markup language paragraph tag and styled using cascading style sheets,
b. said list part outputted using a hypertext markup language list tag,
c. said table of text part outputted using a hypertext markup language table tag,
d. said fillable form part outputted as a text string within a hypertext markup language paragraph tag with at least one or more hypertext markup language form text input tags interspersed within it,
e. said heading part outputted as a text string and styled using cascading style sheets,
f. said link part outputted as a hypertext markup language anchor tag,
g. said bookmark part outputted as a hypertext markup language item comprising a named div tag,
h. said page break part outputted as a text string styled using cascading style sheets,
i. said table of contents part outputted as at least one or more hypertext markup language anchor tags within a structure using hypertext markup language list tags,
j. said table of data part outputted using a hypertext markup language table tag,
k. said list of math operations part outputted using a hypertext markup language list tag,
l. said list of logic operations part outputted using a hypertext markup language list tag,
m. said template of data part outputted using a hypertext markup language table tag with at least one or more hypertext markup language form text input tags interspersed within it,
n. said video part outputted using a hypertext markup language video tag,
o. said audio part outputted using a hypertext markup language audio tag,
p. said image part outputted using a hypertext markup language image tag,
q. said style animation part outputted using cascading style sheets animation style rules applied to hypertext markup language elements,
r. said dynamic image part outputted using a hypertext markup language canvas tag,
s. said dynamic animation part outputted using a hypertext markup language canvas tag,
t. said dynamic graph image part outputted using a hypertext markup language canvas tag, and
u. said dynamic graph animation part outputted using a hypertext markup language canvas tag.

5. The method of claim 4 further including that the styling of alphanumeric content of an electronic document part is comprised of the following steps:
a. taking alphanumeric user input through at least one or more input fields in a hypertext markup language form,
b. parsing said user input into items,
c. connecting said items to input events on a web page wherein an item is connected to an input event,
d. outputting said items into an item display in said web page and listening for the input events,
e. opening style editing options to apply to an item when the input event for the item is triggered and further including that said style editing options are outputted in a portion of the web page substantially adjacent to the portion of the web page containing the item display,
f. taking user input to apply a style to an item wherein said user input is comprised of having selected a style editing option and then entering an input event.

6. The method of claim 5 further including:
a. a slice or split function of said parsing that breaks said user input into said items by applying a function that slices the input text string into the text strings between the delimiter characters within said input text string and stores the text strings between delimiter characters as items in an array and
b. a delimiter character that is an end-of-word character and
c. a prebuilt set of named span tags on the web page wherein a named span tag has been assigned a variable through the document object model by a means for connecting a named hypertext markup language element to a document object model variable, and
d. at least one or more document object model input events assigned to said named span and with at least one or more event listeners to listen for said input events and
e. an identification by said program that identifies a document object model input event for a named span as an indication of a user identification of the word outputted to the web page through that named span.

7. The method of claim 4 further including libraries of operations in said math operations part comprising:
a. arithmetic,
b. algebra,
c. geometry,
d. trigonometry,
e. calculus,
f. linear algebra,
g. scientific experiment math,
h. probability math including standard deviations,
i. financial balance sheets,
j. cash flow statements,
k. profit and loss statements,
l. discounted cash flow,
m. net present value,
n. rate of return,
o. interest and compounded interest,
p. depreciation and amortization,
q. price-earnings ratios,
r. tax calculations, and
s. success rates for process analytics,
and further including libraries of operations in said logic operations part comprising:
a. boolean logic,
b. directional logic,
c. cause and effect logic,
d. legal case analysis logic, and
e. financial analysis logic.

8. The method of claim 4 further including that the user executes a math or logic operation on a table of data by entering an input event for at least a table cell, entering an input event for the operation, entering an input event for at least a second cell, entering an input event for a result command, and entering an input event for at least a third cell, such that this series of steps applies the data in the second cell by the operation to the data in the first cell and outputs the result of the analysis in the third cell.

9. The method of claim 8 further including that the user can enter text into a first cell, enter data into a second cell, and enter a name command that applies the value of the text string in the first cell as the name assigned to the data in the second cell.

10. The method of claim 9 further including that the user can allow a party to upload a data file to said server such that the program will perform the following steps:
a. collect at least one or more name-value pairs from said data file,
b. change a data value in a table of data in said electronic document whose name matches a name in a name-value pair so that the value for the name in the table of data matches the value for the name in said name-value pair,
c. recalculate all operations defined for data cells whose values were so changed, and
d. output the results of recalculations in the changed table of data when outputted as an output web page.

11. The method of claim 4 further including:
a. in said output web page a display of commands of a list comprising:
1. a command to flip to a next page,
2. a command to flip to a previous page,
3. a command to flip to a first page of the document,
4. a command to flip to a last page of the document,
5. a command to activate edit mode in which input events are active,
6. a command to activate read mode in which input events are not active, and
b. the following steps performed by said program in response to a command to flip to a new page:
1. identify the page that is to be served,
2. analyze which part sequence numbers are assigned to said page to be served by analyzing the pagination number and the number of pages into the document of the location of said page to be served and counting forward by the pagination number multiplied by the page number to find the first part to be served and then adding the set of sequence numbers after said first part to be served equal to said pagination number to identify the full group of page parts to be served,
3. identify the unique part identifier for each part whose sequence number falls in the full group of page parts to be served,
4. use the unique part identifier to pull the part from data storage by finding the part record whose unique part identifier matches the target part identifier and then pulling the at least one or more part content fields from that record,
5. output each pulled part content into a hypertext markup language page template comprised of a positional page layout template in an order matching the numbers of the sequence order for the parts,
6. dynamically create the part output for dynamic parts using pulled part content, and
7. if the program setting is selected to display page break parts, also output the page break part at the appropriate location in the page.

12. The method of claim 4 further including configuration such that only one user may edit one electronic document part at one time but any number of users may view one electronic document part at one time and multiple users may edit different parts within the same document at one time.

13. The method of claim 4 further including a public setting for said at least one or more output web pages such that any web browser may enter a URL for a public output web page and be served the public output web page by said server.

14. A machine for creating an electronic document, comprising:
a. a server,
b. a data storage device or computer-readable medium connected to said server by a means for connecting computer hardware,
c. a computer device comprising a computer input device and a computer output display wherein said computer device is connected to an internet connection by a means for making internet connections,
d. a computer program comprised of a server-side script running on said server and a client-side program running on said computer device wherein said computer program creates an electronic document consisting of at least one or more electronic document parts by taking input from said computer device to create said electronic document parts, and wherein said electronic document parts are stored on said data storage device, and
e. further including electronic document part types which define the type of content of said electronic document parts, and wherein said electronic document parts are each of a predetermined size wherein said predetermined size is defined differently for each part type based on the type of content in said part type, and wherein said size is sized for one electronic document part to be able to fill the output display in a mobile device output display and for multiple parts to be able to fill the output display on a laptop output display.

15. The machine of claim 14 further including:
a. a sequence identifier identifying an electronic document part's order within its electronic document,
b. electronic document pages that said electronic document is divided into wherein said electronic document pages are determined by a predetermined pagination number such that the first group of said electronic document parts in a group whose size matches said pagination number are assigned to the first electronic document page, the second group of said electronic document parts in a group whose size matches said pagination number are assigned to the second page, and the process of assigning said electronic document parts to said electronic document pages repeats until all parts are assigned to a page so that each page contains a number of parts equal to the pagination number except for the final page which contains the remainder number of parts, and
c. at least one or more output pages that output at least one or more said electronic document parts of said electronic document comprising:
1. an output page containing the entire electronic document,
2. a series of output pages wherein each output page outputs one electronic document page,
3. an output page containing at least one or more parts selected by a user, or
4. a series of output pages wherein each output page outputs one electronic document part.

16. The machine of claim 15 wherein said electronic document part type is selected from the group consisting of:
a. a text part,
b. a list part,
c. a table of text part,
d. a fillable form part,
e. a heading part,
f. a link part,
g. a bookmark part,
h. a page break part,
i. a table of contents part,
j. a table of data part,
k. a math operations part,
l. a logic operations part,
m. a template of data part,
n. a video part,
o. an audio part,
p. an image part,
q. a style animation part wherein said style animation part presents at least one or more animation sequences in order wherein each animation sequence comprises an animated transition among goal states that transitions from at least one goal state to at least another goal state using an animation style and further including that each goal state takes content from at least one other part in said document and further including that said animated transition is accomplished by applying style changes to said goal states,
r. a dynamic image part wherein at least one or more other parts in said document are dynamically formatted and dynamically outputted into said dynamic image part by said computer program,
s. a dynamic animation part wherein said dynamic animation part presents at least one or more animation sequences wherein each animation sequence comprises an animated transition among goal states that transitions from at least one goal state to at least another goal state using an animation style and further including that each goal state takes content from at least one other part in said document and further including that said animated transition is accomplished by said goal states being dynamically formatted and dynamically outputted into said dynamic animation part by said computer program,
t. a dynamic graph image part wherein said dynamic graph image part is comprised of a graph created from a table of data part processed dynamically by said program by the steps comprised of taking input to determine the sequence order for output items wherein said input assigns a sequence order in the output to a data item in said table of data, identifying a size for said dynamic graph image, identifying a scale that relates a data item in said table of data to said size, and drawing a graph item to said dynamic graph image part wherein the graph item's size corresponds to a corresponding data item from said table of data by reference to said scale and the graph item is drawn in an order defined by the sequence order for the corresponding data item, and
u. a dynamic graph animation part wherein said dynamic graph animation part presents at least one or more animation sequences wherein each animation sequence comprises an animated transition among goal states that transitions from at least one goal state to at least another goal state using an animation style and further including that each goal state takes content from at least one other part in said document and further including that said animated transition is accomplished by said goal states being dynamically formatted and dynamically outputted into said dynamic graph animation part by said computer program and further including that said goal states each take content from at least one said dynamic graph image part.

17. The machine of claim 16 wherein said output pages are output web pages and further including hypertext markup language code in said output web pages and further including:
a. said text part outputted as a text string within a hypertext markup language paragraph tag and styled using cascading style sheets,
b. said list part outputted using a hypertext markup language list tag,
c. said table of text part outputted using a hypertext markup language table tag,
d. said fillable form part outputted as a text string within a hypertext markup language paragraph tag with at least one or more hypertext markup language form text input tags interspersed within it,
e. said heading part outputted as a text string and styled using cascading style sheets,
f. said link part outputted as a hypertext markup language anchor tag,
g. said bookmark part outputted as a hypertext markup language item comprising a named div tag,
h. said page break part outputted as a text string styled using cascading style sheets,
i. said table of contents part outputted as at least one or more hypertext markup language anchor tags within a structure using hypertext markup language list tags,
j. said table of data part outputted using a hypertext markup language table tag,
k. said list of math operations part outputted using a hypertext markup language list tag,
l. said list of logic operations part outputted using a hypertext markup language list tag,
m. said template of data part outputted using a hypertext markup language table tag with at least one or more hypertext markup language form text input tags interspersed within it,
n. said video part outputted using a hypertext markup language video tag,
o. said audio part outputted using a hypertext markup language audio tag,
p. said image part outputted using a hypertext markup language image tag,
q. said style animation part outputted using cascading style sheets animation style rules applied to hypertext markup language elements,
r. said dynamic image part outputted using a hypertext markup language canvas tag,
s. said dynamic animation part outputted using a hypertext markup language canvas tag,
t. said dynamic graph image part outputted using a hypertext markup language canvas tag, and
u. said dynamic graph animation part outputted using a hypertext markup language canvas tag.

18. The machine of claim 17 further including that the styling of alphanumeric content of an electronic document part is comprised of the following steps:
a. taking alphanumeric user input through at least one or more input fields in a hypertext markup language form,
b. parsing said user input into items,
c. connecting said items to input events on a web page wherein an item is connected to an input event,
d. outputting said items into an item display in said web page and listening for the input events,
e. opening style editing options to apply to an item when the input event for the item is triggered and further including that said style editing options are outputted in a portion of the web page substantially adjacent to the portion of the web page containing the item display,
f. taking user input to apply a style to an item wherein said user input is comprised of having selected a style editing option and then entering an input event.

19. The machine of claim 18 further including:
a. a slice or split function of said parsing that breaks said user input into said items by applying a function that slices the input text string into the text strings between the delimiter characters within said input text string and stores the text strings between delimiter characters as items in an array and
b. a delimiter character that is an end-of-word character and
c. a prebuilt set of named span tags on the web page wherein a named span tag has been assigned a variable through the document object model by a means for connecting a named hypertext markup language element to a document object model variable, and
d. at least one or more document object model input events assigned to said named span and with at least one or more event listeners to listen for said input events and
e. an identification by said program that identifies a document object model input event for a named span as an indication of a user identification of the word outputted to the web page through that named span.

20. The machine of claim 17 further including libraries of operations in said math operations part comprising:
a. arithmetic,
b. algebra,
c. geometry,
d. trigonometry,
e. calculus,
f. linear algebra,
g. scientific experiment math,
h. probability math including standard deviations,
i. financial balance sheets,
j. cash flow statements,
k. profit and loss statements,
l. discounted cash flow,
m. net present value,
n. rate of return,
o. interest and compounded interest,
p. depreciation and amortization,
q. price-earnings ratios,
r. tax calculations, and
s. success rates for process analytics,
and further including libraries of operations in said logic operations part comprising:
a. boolean logic,
b. directional logic,
c. cause and effect logic,
d. legal case analysis logic, and
e. financial analysis logic,
and further including that the user executes a math or logic operation on a table of data by entering an input event for at least a table cell, entering an input event for the operation, entering an input event for at least a second cell, entering an input event for a result command, and entering an input event for at least a third cell, such that this series of steps applies the data in the second cell by the operation to the data in the first cell and outputs the result of the analysis in the third cell,
and further including that the user can enter text into a first cell, enter data into a second cell, and enter a name command that applies the value of the text string in the first cell as the name assigned to the data in the second cell.
and further including that the user can allow a party to upload a data file to said server such that the program will perform the following steps:
a. collect at least one or more name-value pairs from said data file,
b. change a data value in a table of data in said electronic document whose name matches a name in a name-value pair so that the value for the name in the table of data matches the value for the name in said name-value pair,
c. recalculate all operations defined for data cells whose values were so changed, and
d. output the results of recalculations in the changed table of data when outputted as an output web page.
